(19) United States
(12) Patent Application Publication
(10) Pub. No.: US 2025/0171691 A1
(43) Pub. Date: May 29, 2025

(54) PHASE DIFFERENCE FILM, POLYMERIZABLE COMPOSITION AND METHOD FOR PREPARING THE PHASE DIFFERENCE FILM

(71) Applicant: Chengdu Rayboch Material Technology Co., Ltd, Chengdu (CN)

(72) Inventors: Xingzhou TU, Chengdu (CN); Jian WANG, Chengdu (CN); Yun HE, Chengdu (CN); Zhihua ZHOU, Chengdu (CN)

(21) Appl. No.: 18/885,659

(22) Filed: Sep. 15, 2024

(30) Foreign Application Priority Data
Nov. 28, 2023 (CN) 2023116151918

(51) Int. Cl. C09K 19/38; G02B 5/30

(52) U.S. Cl. CPC C09K 19/3852; G02B 5/3016

(57) ABSTRACT

The present application discloses a phase difference film, a polymerizable composition and a method for preparing the phase difference film, and relates to the field of optical materials. A phase difference film comprises a first film layer, a second film layer and a third film layer which are sequentially stacked, wherein the first film layer is a spiral A film formed by adding a chiral agent into a positive dispersion type rod-shaped liquid crystal; the second film layer is a C film formed by a positive dispersion type rod-shaped liquid crystal; the third film layer is a spiral A film formed by adding a chiral agent into a positive dispersion type rod-shaped liquid crystal. According to the present application, the problems of poor performance of the phase difference film and the like in the related art can be solved.

### TECHNICAL FIELD

The present application belongs to the technical field of optical materials, and particularly relates to a phase difference film, a polymerizable composition and a method for preparing the phase difference film.

### BACKGROUND

The phase difference film having aeolotropic refractive index is used in various applications such as an anti-reflection film of a display device and an optical compensation film of a liquid crystal display.

The anti-reflection and optical compensation effects achieved by some phase difference films are poor during usage in related art, which will affect the performance of the whole phase difference film.

### SUMMARY

The purpose of the example of the present application is to provide a phase difference film, a polymerizable composition and a method for preparing the phase difference film so as to alleviate the problems such as poor performance of the phase difference film in the related art.

In order to solve the above technical problems, the present application is implemented as follows.

The example of the present application provides a phase difference film comprising a first film layer, a second film layer and a third film layer which are sequentially stacked;

The first film layer is a spiral A film formed by adding a chiral agent into a positive dispersion type rod-shaped liquid crystal;

The second film layer is a C film formed by a positive dispersion type rod-shaped liquid crystal;

The third film layer is a spiral A film formed by adding a chiral agent into a positive dispersion type rod-shaped liquid crystal.

The example of the present application also discloses a polymerizable composition contained in a spiral A film formed by adding a chiral agent into a positive dispersion type rod-shaped liquid crystal, wherein the spiral A film is the spiral A film mentioned above;

The polymerizable composition comprises: an acrylic resin, a first material comprising a compound with formula I, and a second material comprising a compound with formula II;

Formula I is as follows:

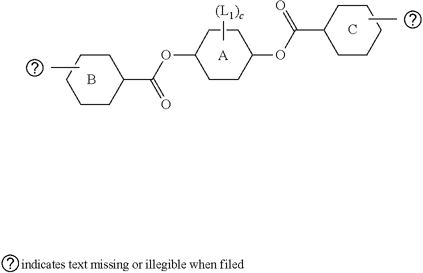

Wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula I,

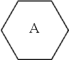

comprises any one of 1,4-cyclohexylene, 1,4-phenylene, 2,6-naphthylene, 1,5-naphthylene and 1,4-naphthylene;

In the formula I,

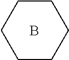

comprises any one of 1,4-cyclohexylene, 1,4-phenylene, 2,6-naphthylene, 1,5-naphthylene, and 1,4-naphthylene;

In the formula I,

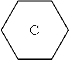

comprises any one of 1,4-cyclohexylene, 1,4-phenylene, 2,6-naphthylene, 1,5-naphthylene, and 1,4-naphthylene;

Sp₁ is a spacer, Sp₂ is a spacer;

P₁ comprises a polymerizable group or H, P₂ comprises a polymerizable group or H, and at least one of P₁ and P₂ is a polymerizable group;

a is 1, 2 or 3; b is 1, 2 or 3; c is 1, 2 or 3;

The formula II is as follows:

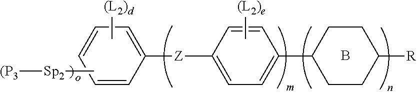

In the formula II, R comprises any one of H, a linear chain alkyl group having 1 to 25 carbon atoms, a branched chain alkyl group having 3 to 25 carbon atoms, and a cyclic alkyl group having 3 to 25 carbon atoms;

Z comprises any one of a single bond, an alkyl group having 1 to 10 carbon atoms, and an alkenyl group having 2 to 10 carbon atoms;

L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

L₃ comprise any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula II,

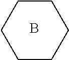

comprises any one of an aryl group, a heteroaryl group, an alicyclic group, a heterocyclic group and a fused ring;

Sp₃ is a spacer;

P₃ comprises a polymerizable group or H;

d is 0, 1, 2, 3 or 4;

e is 0, 1, 2, 3 or 4;

m is 0, 1 or 2, n is 0, 1 or 2, and m+n≥1;

o is 1, 2, or 3.

The example of the present application also discloses another polymerizable composition contained in a C film formed by a positive dispersion type rod-shaped liquid crystal, wherein the C film is the C film mentioned above.

The polymerizable composition comprises an acrylic resin, a first material and a second material, wherein the first material comprises a compound with a formula I, and the second material comprises a compound with a formula II and/or a compound with a formula III;

The formula I is as follows:

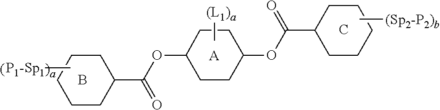

Wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula I,

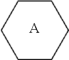

comprises any one of 1,4-cyclohexylene, 1,4-phenylene, 2,6-naphthylene, 1,5-naphthylene and 1,4-naphthylene;

In the formula I,

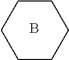

comprises any one of 1,4-cyclohexylene, 1,4-phenylene, 2,6-naphthylene, 1,5-naphthylene, and 1,4-naphthylene;

In the formula I,

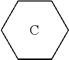

comprises any one of 1,4-cyclohexylene, 1,4-phenylene, 2,6-naphthylene, 1,5-naphthylene, and 1,4-naphthylene;

Sp₁ is a spacer, Sp₂ is a spacer;

P₁ comprises a polymerizable group or H, P₂ comprises a polymerizable group or H, and at least one of P₁ and P₂ is a polymerizable group;

a is 1, 2 or 3; b is 1, 2 or 3; c is 1, 2 or 3;

The formula IV is as follows:

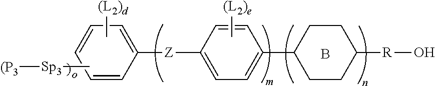

The formula III is as follow:

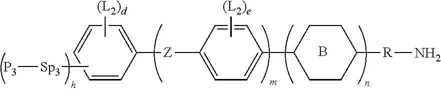

In the formula II and the formula III, R comprises any one of H, a linear chain alkyl group having 1 to 25 carbon atoms, a branched chain alkyl group having 3 to 25 carbon atoms, and a cyclic alkyl group having 3 to 25 carbon atoms;

Z comprises any one of a single bond, an alkyl group having 1 to 10 carbon atoms, and an alkenyl group having 2 to 10 carbon atoms;

L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

L₃ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula IV and the formula III,

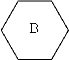

comprises any one of an aryl group, a heteroaryl group, an alicyclic group, a heterocyclic group and a fused ring;

Sp₃ is a spacer;

P₃ comprises a polymerizable group or H;

d is 0, 1, 2, 3 or 4;

e is 0, 1, 2, 3 or 4;

f is 0, 1, 2, 3 or 4;

g is 0, 1, 2, 3 or 4;

m is 0, 1 or 2, n is 0, 1 or 2, and m+n≥1;

o is 1, 2 or 3 and h is 1, 2 or 3.

The example of the present application also provides a method for preparing the phase difference film, which is used for preparing the phase difference film, and the preparation method comprises the following steps:

Treating substrate;

Coating an alignment layer on the substrate;

Coating a horizontally aligned liquid crystal layer on the alignment layer;

Coating a vertically aligned liquid crystal layer on the substrate;

The horizontally aligned liquid crystal layer, the vertically aligned liquid crystal layer, and the horizontally aligned liquid crystal layer are laminated to form a phase difference film.

The example of the present application also provides another method for preparing the phase difference film, which is used for preparing the phase difference film and comprises the following steps:

Treating substrate;

Coating an alignment layer on the substrate;

Coating a horizontally aligned liquid crystal layer on the alignment layer;

Coating an alignment layer and a horizontally aligned liquid crystal layer on the substrate;

The horizontally aligned liquid crystal layer, the alignment layer, a vertically aligned liquid crystal layer and the horizontally aligned liquid crystal layer are laminated to form a phase difference film.

According to the phase difference film in the example of the present application, unpolarized light in a visible light wave band can be incident from the POL side at different angles and is close to circularly polarized light when the unpolarized light passes through the phase difference film and then is emitted to the OLED, so that the light passes through the phase difference film, is reflected by OLED, and passes through the phase difference film again, and the final transmittance will be close to 0, thereby ensuring that the phase difference film has better performance.

### BRIEF DESCRIPTION OF DRAWINGS

FIG. 1 is a schematic diagram of a thin film structure disclosed in an example of the present application;

FIG. 2 is a schematic diagram of a simulation result of Example 1 disclosed in an example of the present application;

FIG. 3 is a schematic diagram of a simulation result of Example 2 disclosed in an example of the present application;

FIG. 4 is a schematic diagram of a simulation result of Example 3 disclosed in an example of the present application;

FIG. 5 is a schematic diagram of a simulation result of Comparative Example 1 disclosed in an example of the present application;

FIG. 6 is a schematic diagram of a simulation result of Comparative Example 2 disclosed in an example of the present application;

FIG. 7 is a schematic diagram of a simulation result of Comparative Example 3 disclosed in an example of the present application;

FIG. 8 is a schematic diagram of a preparation process of a first phase difference film disclosed in an example of the present application;

FIG. 9 is a schematic diagram of a preparation process of a second phase difference film disclosed in an example of the present application.

### DESCRIPTION OF REFERENCE NUMERALS

100—the first film layer;
200—the second film layer;
300—the third film layer;
400—substrate;
500—POL;
600—OLED.

### DESCRIPTION OF PREFERRED EMBODIMENTS

The technical solutions in the examples of the present application will be clearly and completely described below with reference to the drawings in the examples of the present application. Obviously, the described examples are part of the examples of the present application, but not all of the examples. Based on the examples in the present application, all other examples obtained by those skilled in the art without creative work are within the scope of the present application.

The terms “first,” “second”, etc. in the description and the claims of this application are used for distinguishing between similar objects and not for describing a particular ordering or precedence order. It is to be understood that the used data may be interchanged under appropriate circumstances so that examples of the present application may be practiced in an order other than those illustrated or described herein, and that the objects distinguished by “first”, “second”, etc. are generally of a type and the number of objects are not limited, e.g., the first object may be one or more. In addition, “and/or” in the description and the claims means at least one of the connected objects, and the character “/” generally means that the associated object is in an “or” relationship.

Hereinafter, the examples of the present application will be described in detail through specific examples and application scenarios thereof with reference to the drawings.

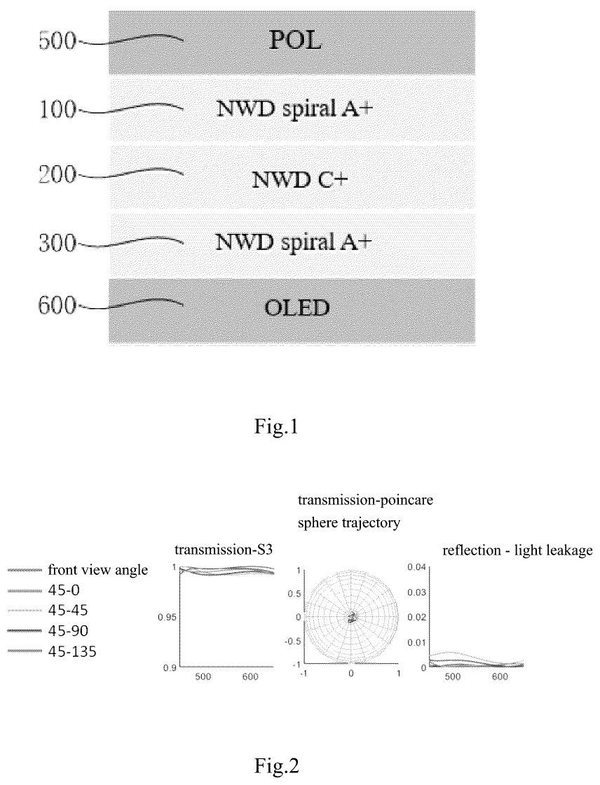

Referring to FIG. 1, an example of the present application discloses a phase difference film. The disclosed phase difference film comprises a first film layer 100, a second film layer 200, and a third film layer 300, and the first film layer 100, the second film layer 200, and the third film layer 300 are sequentially stacked.

Wherein, the first film layer 100 is a spiral A film formed by adding a chiral agent into a positive dispersion type rod-shaped liquid crystal, the second film layer 200 is a C film formed by a positive dispersion type rod-shaped liquid crystal, and the third film layer 300 is a spiral A film formed by adding a chiral agent into a positive dispersion type rod-shaped liquid crystal.

According to the phase difference film in the example of the present application, the non-polarized light in the visible light band can be incident from the POL500 side at different angles, and is close to circularly polarized light when the unpolarized light passes through the phase difference film and then is emitted to the OLED 600, that is, the absolute value of the S3 component of the normalized Stokes vector is close to 1, and on the Poincare sphere, it appears that the polarization state is rotated to near the pole. If this goal is achieved, the final transmittance of the light after passing through the phase difference film, reflected by the OLED 600, and passing through the phase difference film again will be close to 0, thereby ensuring that the phase difference film has better performance.

In order to achieve the above optimization objective, the example of the present application is designed for the phase difference film, specifically as follows:

The first layer may be an absorptive polarizer (POL 500) having an absorption axis at an angle of 0°.

The second layer may be a spiral A film formed by adding a chiral agent to a positive dispersion type (NWD) rod-shaped liquid crystal, i.e., the first film layer 100. The orientation angle of the liquid crystal molecules on the side of the first film layer 100 away from the second film layer 200 may range from −30° to 30°, that is, the orientation angle of the liquid crystal molecules on the side close to the POL 500 may range from −30° to 30°, and preferably, the orientation angle of the liquid crystal molecules may range from −20° to 20°.

The purpose of using the value range of the orientation angle of the liquid crystal molecules is to obtain a nearly smooth and continuous refractive index at the interface between the POL 500 and the first film layer 100, so that the interface reflection is as small as possible. Of course, it is also possible to make the e-axis of the POL 500 and the initial e-axis of the first film layer 100 (the e-axis refers to the axis related to the non-trivial refractive index) as close as possible.

In addition, the total twist angle of the obliquely incident liquid crystal molecules may range from −60° to 60°, that is, the total twist angle of the liquid crystal molecules of the first film layer 100 may range from −60° to 60°; preferably, the total twist angle of the liquid crystal molecules may range from ±10° to 30°, or from ±400 to 60°.

The purpose of adopting the value range of the total twist angle of the liquid crystal molecules is to approach the superposition effect of multiple layers of spiral A film at different angles by the twisting of the liquid crystal molecules, so as to compensate for the change in the polarization property of phase difference film at different viewing angles.

In some examples, the value of (ne-no) at a wavelength of 550 nm multiplied by the film thickness of the first film layer 100 may be in the range of 150 nm to 450 nm, preferably, the value may be in the range of 200 nm to 400 nm.

The adoption of the above value range aims to allow the first film layer 100 to have a certain degree of phase difference, and the phase difference is related to the wavelength and the incident angle, the incident light on the Poincare sphere appears to rotate from the transmission axis of the POL 500 (a point on the equator) to near another position on the sphere (the specific position is related to the wavelength) when passing through the first film layer 100, then rotates back to the pole in the subsequent layer, and compensates for the phase difference deviation between different wavelengths by multiple rotations, so that the light of different wavelengths rotates to near the pole.

The third layer is a C film formed by a positive dispersion type rod-shaped liquid crystal, that is, the second film layer 200.

Wherein, the value of (ne-no) at a wavelength of 550 nm multiplied by the thickness of the second film layer 200 ranges from 40 nm to 250 nm. Preferably, the value may range from 50 nm to 140 nm, or from 160 nm to 240 nm.

The adoption of the above values aims to allow the second film layer 200 to have a certain degree of phase difference, and the phase difference is related to the wavelength and the incident angle, the liquid crystal orientation of the second film layer 200 is perpendicular to the film, and the liquid crystal orientation of the first film layer 100 is parallel to the in-plane direction of the film. As a result, the deviation direction of the phase difference of the two film layers during oblique incidence is diametrically opposite to the deviation direction of the phase difference of the two film layers during normal incidence, and the polarization property difference of the phase difference film during oblique incidence can be compensated through the combination of the spiral A film and the spiral C film, so that light with different incidence angles can be finally rotated to near the pole.

The fourth layer is a spiral A film formed by adding a chiral agent into the positive dispersion type (NWD) rod-shaped liquid crystal, that is, the third film layer 300.

The orientation angle of the liquid crystal molecules on the side of the third film layer 300 away from the second film layer 200 may range from +0° to 20°, or from 65° to 90°, preferably from 70° to 90°.

The purpose of adopting the above values is to adjust the rotation direction of the third film layer 300 for the polarization state, so that the polarization state can be finally rotated to near the pole.

The total twist angle of the liquid crystal molecules of the third film layer 300 may range from ±70° to 200°, preferably range from ±75° to 95°, or from ±1700 to 2000.

The purpose of adopting the above value is to approach the superposition effect of multiple layers of spiral A film at different angles by the twisting of the liquid crystal molecules, so as to compensate for the change in the polarization property of phase difference film at different viewing angles.

In addition, the value of (ne−no) at a wavelength of 550 nm multiplied by the film thickness of the third film layer 300 is in the range of 100 nm to 370 nm, and preferably, the value is in the range of 110 nm to 200 nm or 270 nm to 350 nm.

The purpose of adopting the above value is to adjust the phase difference of the third film layer 300, so that the polarization state of the light rotates back to the pole when passing through the third film layer 300.

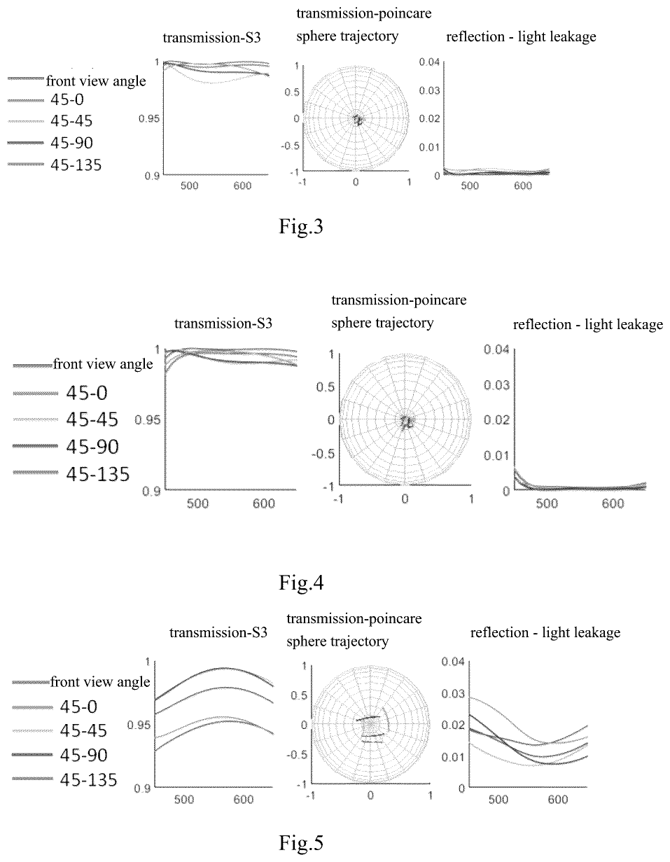

In the example of the present application, when the respective parameters of the first film layer 100, the second film layer 200, and the third film layer 300 are taken from the preferred parameter intervals, the simulation results thereof are shown in FIG. 2 to FIG. 4.

Transmission-S3 is the S3 component of the normalized Stokes vector of the emergent light in transmission mode (i.e., with the OLED 600 screen being removed and light is incident from the POL 500 side), and its absolute value is as close to 1 as possible.

The transmission-Poincare sphere trajectory is the trajectory of the normalized Stokes vector of the emergent light of different wavelengths in the transmission mode on the Poincare sphere, the closer to the center, the better.

Reflection-light leakage is the reflected light intensity divided by the incident light intensity in the reflection mode (i.e., OLED600 screen is comprised in the modeling and Mo metal is used in the model to simulate the reflective layer of the OLED600), the smaller the better.

The results shown in FIGS. 2 to 4 are the simulation results when the film is rotated by 0°, 45°, 90°, and 135° in the plane at a front viewing angle and an oblique incidence angle of 45° (that is, the angle between the incident light and the normal of the film).

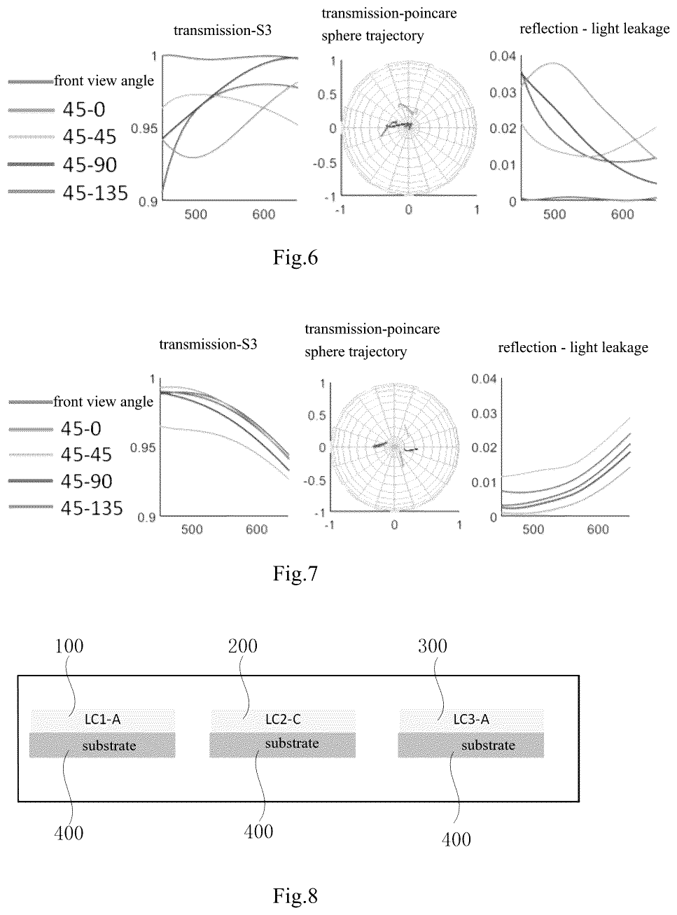

In the example of the present application, when part of the parameters of the first film layer 100, the second film layer 200, and the third film layer 300 are taken from outside of the above parameter interval, the simulation results thereof are shown in FIG. 5 to FIG. 7.

For example, in Comparative Example 1, when the angle of the first film layer 100 is not within the above parameter interval (e.g., the orientation angle of the liquid crystal molecules is not within the range of −30° to 30°, and the total twist angle of the liquid crystal molecules is not within the range of −60° to 60°), and the film thickness of the first film layer 100 is not within the range of 150 nm to 450 nm, the absolute value of the transmission-S3 is far away from 1, the transmission-Poincare sphere trajectory is far away from the center, and the result where the reflected light intensity divided by the incident light intensity in the transmission-leakage light is larger. Therefore, the actual demand cannot be met.

In Comparative Example 2, the film thickness of the second film layer 200 is not within the range of 40 nm to 250 nm, the absolute value of the transmission-S3 is far away from 1, the transmission-Poincare sphere trajectory is far away from the center, and the result where the reflected light intensity divided by the incident light intensity in the transmission-leakage light is larger. Therefore, the actual demand cannot be met.

In Comparative Example 3, the film thickness of the third film layer 300 is not within the range of 100 nm to 370 nm, the absolute value of the transmission-S3 is far away from 1, the transmission-Poincare sphere trajectory is far away from the center, and the result where the reflected light intensity divided by the incident light intensity in the transmission-leakage light is larger. Therefore, the actual demand cannot be met.

It can be seen that when part of the parameters of the first film layer 100, the second film layer 200, and the third film layer 300 are taken from outside of the above parameter interval, transmission-S3 and Reflection-light leakage are significantly inferior to those in Examples 1 to 3, and the Poincare sphere trajectory is significantly deviated from the pole.

In the present disclosure, “acrylic (methacrylic) resin” means an acrylic (methacrylic) monomer or other resin modified with acrylic (methacrylic), which has no liquid crystalline property and has a molecular weight distribution of 200 to 2,000.

In that present disclosure, the “solvent” is not particularly limit to an organic solvent, but is preferably an organic solvent in which the polymerizable compound composition exhibits good solubility, and is preferably an organic solvent which can be dry at 100° C. or less. Examples of such solvents comprise aromatic hydrocarbons such as toluene, xylene, cumene, and mesitylene, ester-based solvents such as methyl acetate, ethyl acetate, propyl acetate, and butyl acetate, ketone-based solvents such as methyl ethyl ketone, methyl isobutyl ketone, cyclohexanone, and cyclopentanone, ether-based solvents such as tetrahydrofuran, 1,2-dimethoxyethane, and anisole, amide-based solvents such as N,N-dimethylformamide and N-methyl-2-pyrrolidone, propylene glycol monomethyl ether acetate, diethylene glycol monomethyl ether acetate, γ-butyrolactone, and chlorobenzene. These organic solvents may be used singly or as a mixture of two or more, but from the viewpoint of solution stability, one or more of ketone-based solvents, ether-based solvents, ester-based solvents, and aromatic hydrocarbon solvents are preferably used.

The composition used in the present disclosure can be coated to a substrate as long as it is made into a solution of an organic solvent, and the proportion of the organic solvent used in the polymerizable composition is not particularly limited as long as it does not significantly impair the state of the coating, but the total amount of the organic solvent contained in the polymerizable composition is preferably from 30% to 95% by mass, more preferably from 40% to 90% by mass, and particularly preferably from 50% to 85% by mass.

When the polymerizable composition is dissolved in the organic solvent, it is preferably heated and stirred for uniform dissolution. The heating temperature at the time of heating and stirring may be appropriately adjusted preferably in consideration of the solubility of the composition used in the organic solvent, and from the viewpoint of productivity, it is preferably 15° C. to 110° C., more preferably 15° C. to 105° C., further preferably 15° C. to 100° C., and particularly preferably 20° C. to 60° C.

In the present disclosure, the “initiator” refer to a photopolymerization initiator, and preferably comprises at least one of them. In particular, examples of initiator comprise: Irgacure 651, Irgacure 184, Darocur 1173, Irgacure 907, Irgacure 127, Irgacure 369, Irgacure 379, “Irgacure 819”, “Irgacure2959”, “Irgacure 1800”, “Irgacure 250”, “Irgacure 754”, “Irgacure784”, “Irgacure OXE01”, “Irgacure OXE02”, “Lucirin TPO”, “Darocur 1173”, “Darocur MBF” manufactured by BASF Japan Co., Ltd.; “Esacure 1001M”, “Esacure KIP150”, “Speedcure BEM”, “Speedcure BMS”, “Speedcure MBP”, “Speedcure PBZ”, “Speedcure ITX”, “Speed cure DETX”, “Speedcure EBD”, “Speedcure MBB”, “Speedcure BP” manufactured by LAMBSON Corporation; “Kayacure DMBI” manufactured by Nippon Kayaku Co., Ltd.; “TAZ-A” manufactured by Nihon Siber Hegner Co., Ltd. (now DKSH Japan Co., Ltd); and “Adeka Optomer SP-152”, “Adeka Optomer SP-170”, “Adeka OptomerN-1414”, “Adeka Optomer N-1606”, “Adeka Optomer N-1717”, “Adeka Optomer N-1919”, etc. manufactured by ADEKA Co., Ltd.

The photopolymerization initiator is preferably used in an amount of 0.1% to 10% by mass, particularly preferably 0.5% to 7% by mass, based on the polymerizable composition. These photopolymerization initiators may be used alone or in a mixture of two or more, and a sensitizer or the like may be added.

In the present disclosure, the “additive” is a component to improve the stability of the polymerizable composition of the present disclosure, and comprises an antioxidant, a surfactant, a polymerization inhibitor, a chain transfer agent, and the like. One or more of these additives can be selectively added or not added according to the stability of the formula.

Polymerization inhibitor: it is preferred to add a polymerization inhibitor to the polymerizable composition of the present disclosure. Examples of the polymerization inhibitor comprise phenolic compounds, quinone compounds, amine compounds, thioether compounds, and nitroso compounds. Examples of the phenolic compound comprise p-methoxyphenol, cresol, t-butyl catechol, 3,5-di-t-butyl-4-hydroxy toluene, 2,2′-methylenebis (4-methyl-6-t-butylphenol), 2,2′-methylenebis (4-ethyl-6-t-butylphenol), 4,4′-thiobis(3-methyl-6-t-butylphenol), 4-methoxy-1-naphthol, 4,4′-dialkoxy-2,2′-bi-1-naphthol, and the like. Examples of the quinone compound comprise: hydroquinone, methylhydroquinone, t-butylhydroquinone, p-benzoquinone, methyl-p-benzoquinone, t-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, diphenoquinone, and the like. Examples of the amine compound comprise: p-phenylenediamine, 4-aminodiphenylamine, N,N′-diphenyl-p-phenylenediamine, N-isopropyl-N′-phenyl-p-phenylenediamine, N-(1,3-dimethylbutyl)-N′-phenyl-p-phenylenediamine, N, N′-di-2-naphthyl-p-phenylenediamine, diphenylamine, N-phenyl-o-naphthylamine, 4, 4′-dicumyl-diphenylamine, 4, 4′-dioctyl-diphenylamine, etc. Examples of the thioether compound comprise: phenothiazine and thiodipropionic acid distearyl ester and the like. Examples of the nitroso compound comprise: N-nitrosodiphenylamine, N-nitrosophenylnaphthylamine, N-nitrosodinaphthylamine, p-nitrosophenol, nitrosobenzene, p-nitrosodiphenylamine, a-nitroso-o-naphthol, etc., N, N-dimethyl-p-nitrosoaniline, p-nitrosodiphenylamine, p-nitrosodimethylamine, p-nitroso-N, N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2, 4, 6-tri-tert-butylnitrosobenzene, N-nitroso-N-methyl-p-toluenesulfonamide, N-nitroso-N-ethylcarbamate, N-nitroso-N-n-propylcarbamate, 1-nitroso-2-naphthol, 2-nitroso-1-naphthol, 1-nitroso-2-naphthol-3,6-sulfonic acid sodium salt, 2-nitroso-1-naphthol-4-sulfonic acid sodium salt, 2-nitroso-5-methylaminophenol hydrochloride, 2-nitroso-5-methylaminophenol hydrochloride and the like. The polymerization inhibitor is preferably added in an amount of 0.01% to 1.0% by mass, more preferably 0.05% to 0.5% by mass, based on the polymerizable composition.

Antioxidant: to improve the stability of the polymerizable composition of the present disclosure, it is preferable to add an antioxidant or the like. Examples of such compounds comprise hydroquinone derivatives, nitrosamine polymerization inhibitors, and hindered phenol antioxidants, and more specifically, examples of antioxidants comprise: tert-butylhydroquinone, methylhydroquinone; Q-1300 and Q-1301 manufactured by Wako Pure Chemical Industries, Ltd.; “IRGANOX1010”, “IRGANOX1035”, “IRGANOX1076”, “IRGANOX1098”, “IRGANOX1135”, “IRGANOX1330”, “IRGANOX1425”, “IRGANOX1520”, “IRGANOX1726”, “IRGANOX245”, “IRGANOX259”, “IRGANOX 3114”, “IRGANOX3790”, “IRGANOX5057”, “IRGANOX565”, etc. manufactured by BASF Corporation. The amount of the antioxidant to be added is preferably from 0.01 to 2.0% by mass, and more preferably from 0.05 to 1.0% by mass, based on the polymerizable liquid crystal composition.

Surfactant: the polymerizable composition of the present disclosure may comprise at least one or more surfactants in order to reduce the unevenness of the film thickness at the time of forming the optically anisotropic body. Examples of the surfactant that may be contained comprise: alkylcarboxylates, alkylphosphates, alkylsulfonates, fluoroalkylcarboxylates, fluoroalkylphosphates, fluoroalkylsulfonates, polyoxyethylene derivatives, fluoroalkyloxirane derivatives, polyethylene glycol derivatives, alkylammonium salts, and fluoroalkylammonium salts, and fluorine-containing surfactants are particularly preferred. In particular, Examples of the surfactant comprise: “Megafac F-251”, “Megafac F-444”, “Megafac F-477”, “Megafac F-510”, “Megafac F-552”, “Megafac F-553”, “Megafac F-554”, “MegafacF-555”, “Megafac F-556”, “Megafac F-557”, “Megafac F-558”, “Megafac F-559”, “Megafac F-560”, “Megafac F-561”, “Megafac F-562”, “Megafac F-563”, “MegafacF-565”, “Megafac F-567”, “Megafac F-568”, “Megafac F-569”, “Megafac F-570”, “Megafac F-571”, “Megafac R-40”, “Megafac R-41”, “Megafac R-43”, “Megafac R-94”, “Megafac RS-72-K”, “Megafac RS-75”, “Megafac RS-76-E”, “Megafac RS-90” (the above are manufactured by DIC Corporation); “Ftergent 100”, “Ftergent 100C”, “Ftergent 110”, “Ftergent 150”, “Ftergent 150CH”, “Ftergent A”, “Ftergent 100A-K”, “Ftergent 501”, “Ftergent 300”, “Ftergent 310”, “Ftergent 320”, “Ftergent 400SW”, “FTX-400P”, “Ftergent 251”, “Ftergent 215M”, “Ftergent 212MH”, “Ftergent 250”, “Ftergent 222F”, “Ftergent 212D”, “FTX-218”, “FTX-209F”, “FTX-213F”, “FTX-233F”, “Ftergent 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FTX-730LL”, “FTX-710LL” (the above are manufactured by Noes Corporation), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK—UV3500”, “BYK—UV3510”, “BYK—UV3570”, “BYK Silclean 3700” (the above are manufactured by BYK-Chemie Japan Corporation), “TEGO Rad2100”, “TEGO Rad2200N”, “TEGO Rad2250”, “TEGO Rad2300”, “TEGORad2500”, “TEGO Rad2600”, “TEGO Rad2700” (manufactured by Tego Corporation); “N215”, “N535”, “N605K”, and “N935” (manufactured by Solvay Solexis Corporation).

The amount of the surfactant to be added is preferably from 0.01% to 2% by mass, and more preferably from 0.05% to 0.5% by mass, based on the polymerizable composition. In addition, by using the surfactant, the inclination angle of the air interface can be effectively reduced when the polymerizable composition of the present disclosure is made into an optically anisotropic body, and, it is possible to achieve good orientation by using the above-mentioned surfactants. Surprisingly, it is clarified that if the surfactant is used in combination with polymeric haze improver, the orientation could be significantly improved due to the synergistic effect.

Chain transfer agent: it is also preferable to add a chain transfer agent to the polymerizable composition of the present disclosure in order to improve adhesion to a substrate when the polymerizable composition is made into an optically anisotropic body. The chain transfer agent is preferably a thiol compound, more preferably a monothiol, dithiol, trithiol, or tetrathiol compound, and still more preferably a trithiol compound. The amount of the chain transfer agent added is preferably from 0.5% to 10% by mass, and more preferably from 1.0 to 5.0% by mass, based on the polymerizable liquid crystal composition.

Chiral agent: the chiral agent of the present disclosure refers to a compound with a chiral structure that can distort the liquid crystal, such as commercially available LC756.

In the present disclosure, “907” is a photoinitiator of “Irgacure 907” manufactured by BASF Japan Corporation.

In the present disclosure, the “base film” is a carrier for carrying a polymerizable composition, and the substrate used in the optically anisotropic body of the present disclosure is not particularly limited as long as it is a substrate commonly used in liquid crystal devices, displays, optical parts, and optical films and is a material having the following heat resistance. The heat resistance means resistance to heating at the time of drying after coating the polymerizable compound composition of the present disclosure. Examples of such substrates comprise organic materials such as glass substrates, metal substrates, ceramic substrates, plastic substrates and the like. In particular, when the substrate is an organic material, examples thereof comprise cellulose derivatives, polyolefins, polyesters, polycarbonates, polyacrylates (acrylic resins), polyarylates, polyether sulfones, polyimides, polyphenylene sulfides, polyphenylene ethers, nylons, and polystyrenes. Among them, a plastic base material such as polyester, polystyrene, polyacrylate, polyolefin, cellulose derivative, polyarylate, and polycarbonate is preferable, and substrate such as metal, polyethylene terephthalate (PET), and cellulose derivative is more preferable. The shape of the substrate may have a curved surface in addition to a flat plate. These substrates may have an electrode layer, an antireflection function, and a reflection function as needed.

In the present disclosure, “coating” refers to a coating method for obtaining the polymerizable composition of the present disclosure. Known conventional methods such as a coater method, a rod coating method, a spin coating method, a roll coating method, a direct gravure coating method, a reverse gravure coating method, a flexo coating method, an ink-jet method, a die coating method, a cap coating method, a dip coating method, and a slit coating method can be performed. After the polymerizable composition is coated, it is dried as necessary.

The example of the present application also discloses a polymerizable composition, which is contained in a spiral A film formed by adding a chiral agent into a positive dispersion type rod-shaped liquid crystal, wherein the spiral A film is the spiral A film described above.

A polymerizable composition forming the spiral A film comprises: acrylic resin, a first material and a second material, wherein the first material comprises a compound with a formula I, and the second material comprises a compound with a formula II.

Wherein the formula I is as follows:

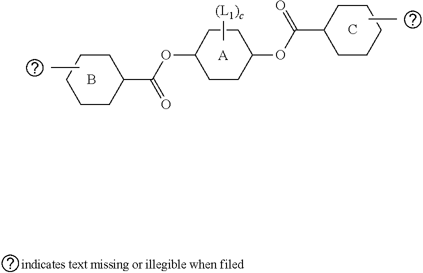

Wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms.

Wherein, in the formula I,

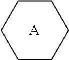

comprises any one of 1,4-cyclohexylene, 1,4-phenylene, 2,6-naphthylene, 1,5-naphthylene and 1,4-naphthylene;

In the formula I,

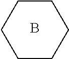

comprises any one of 1,4-cyclohexylene, 1,4-phenylene, 2,6-naphthylene, 1,5-naphthylene, and 1,4-naphthylene;

In the formula I,

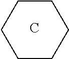

comprises any one of 1,4-cyclohexylene, 1,4-phenylene, 2,6-naphthylene, 1,5-naphthylene, and 1,4-naphthylene;

Sp₁ is a spacer, Sp₂ is a spacer;

P₁ comprises a polymerizable group or H, P₂ comprises a polymerizable group or H, and at least one of P₁ and P₂ is a polymerizable group;

a is 1, 2 or 3; b is 1, 2 or 3; b is 1, 2 or 3.

Formula II is as follows:

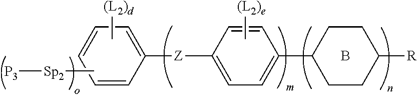

In the formula II, R comprises any one of a polymerizable group P₃—Sp₃-, H, a linear chain alkyl group having 1 to 25 carbon atoms, a branched chain alkyl group having 3 to 25 carbon atoms, and a cyclic alkyl group having 3 to 25 carbon atoms;

Z comprises any one of a single bond, an alkyl group having 1 to 10 carbon atoms, and an alkenyl group having 2 to 10 carbon atoms;

L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

L₃ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms, wherein any two non-adjacent carbon atoms can be substituted by —O—, —S—, —OCO—, etc.;

In the formula II,

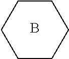

comprises any one of an aryl group, a heteroaryl group, an alicyclic group, a heterocyclic group and a fused ring;

Sp₃ is a spacer;

P₃ comprises a polymerizable group or H;

d is 0, 1, 2, 3 or 4;

e is 0, 1, 2, 3 or 4;

m is 0, 1 or 2, n is 0, 1 or 2, and m+n≥1;

o is 1, 2, or 3.

Preferably, the aforementioned compound of formula I is preferably selected from the group consisting of I1 to I31:

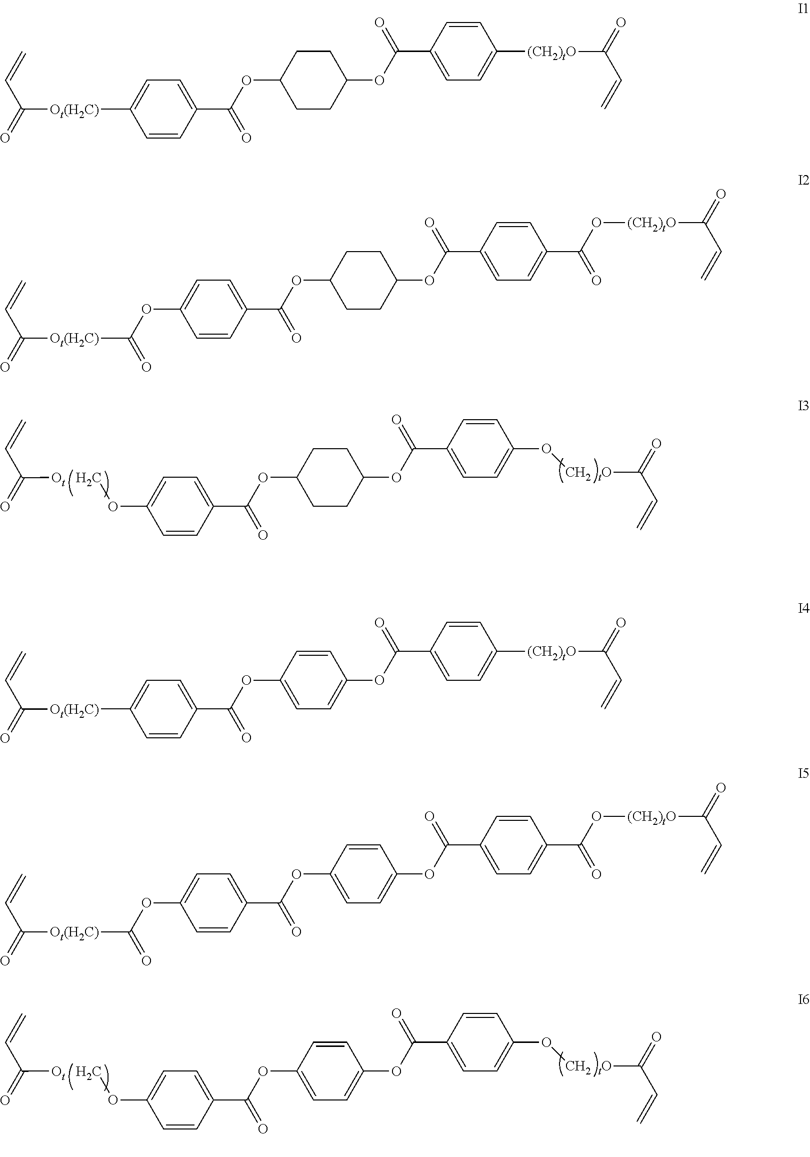

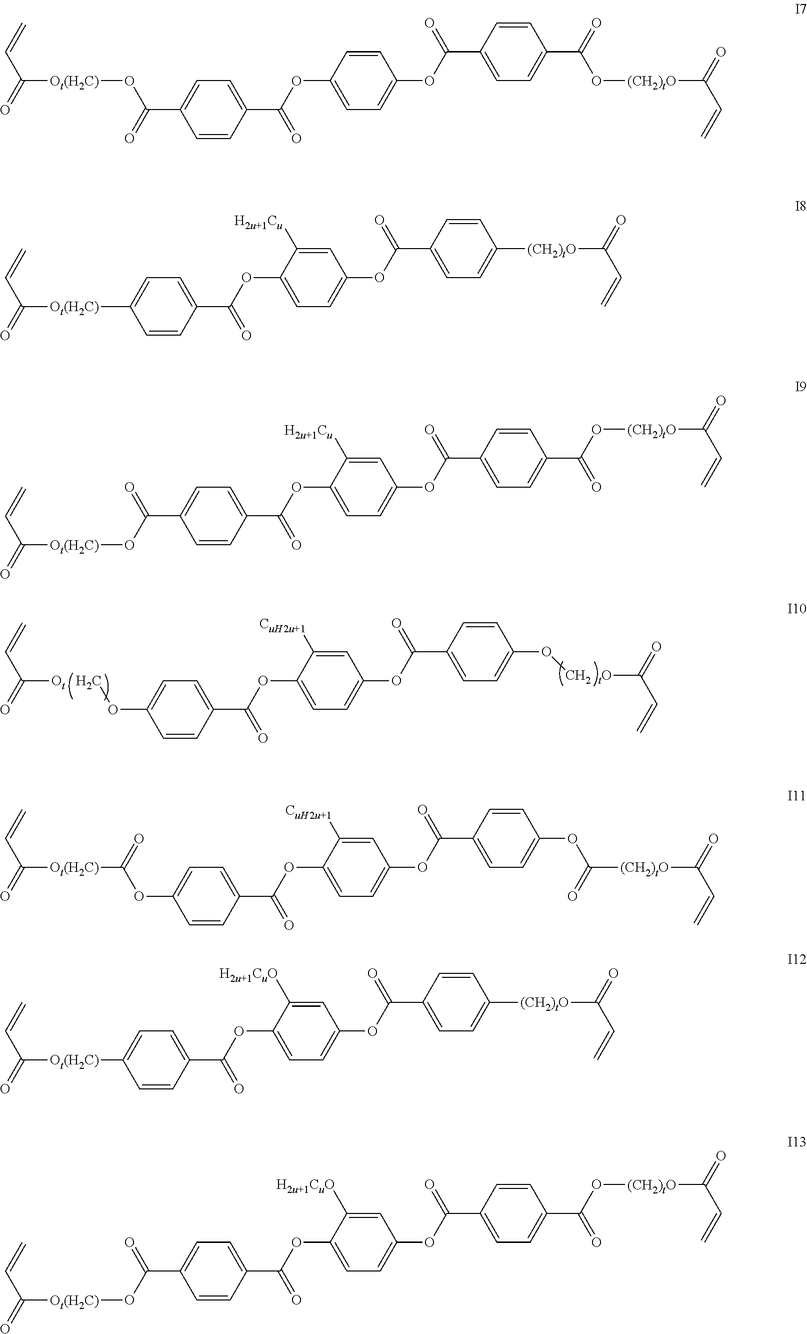

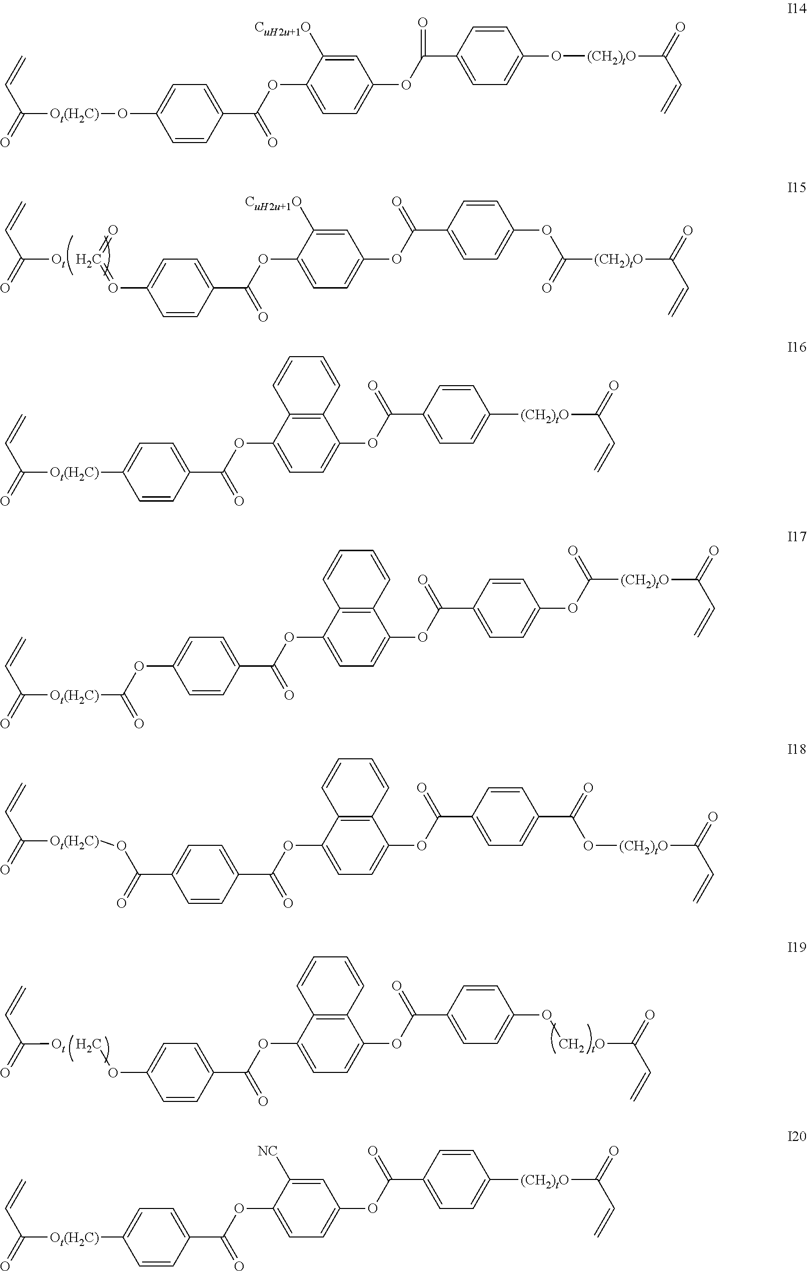

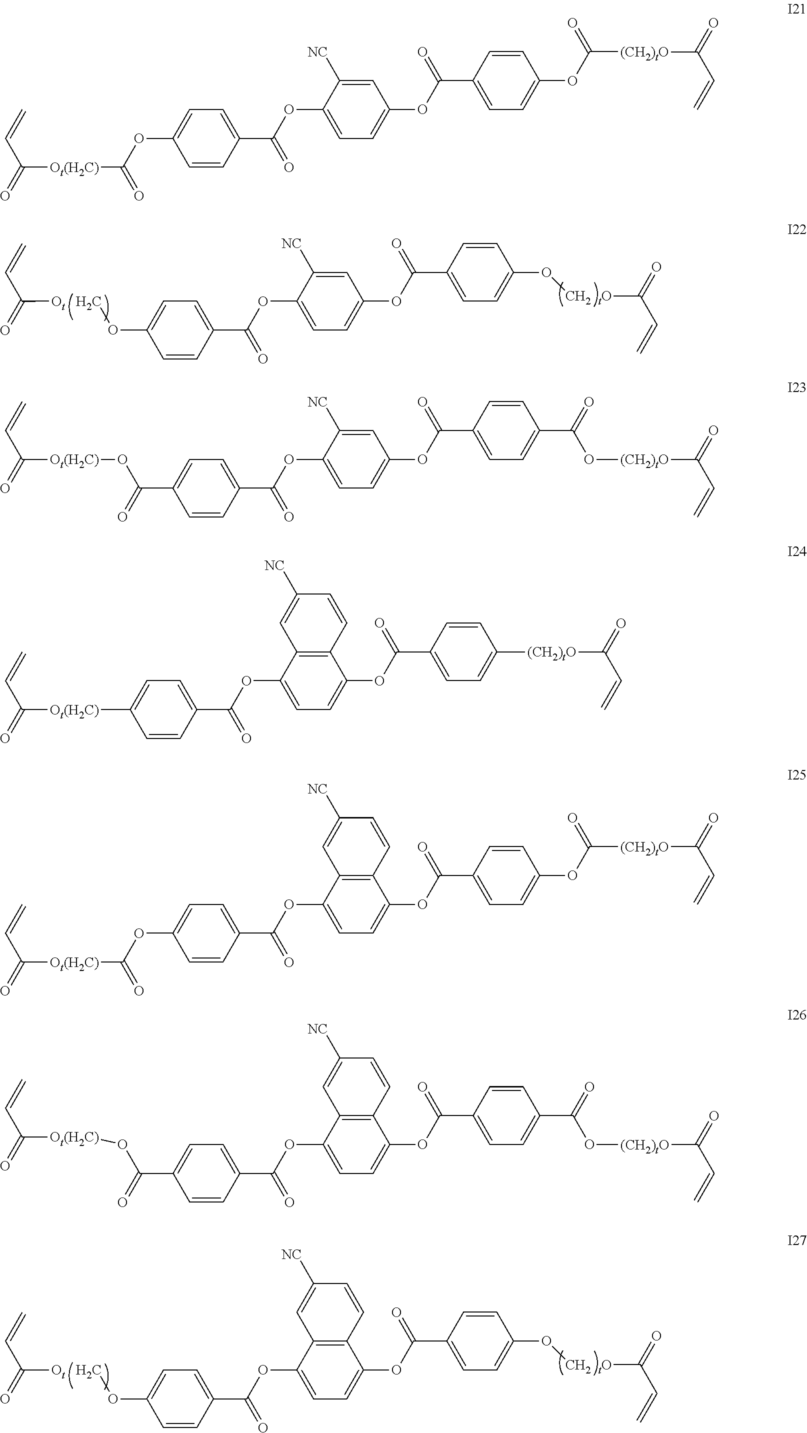

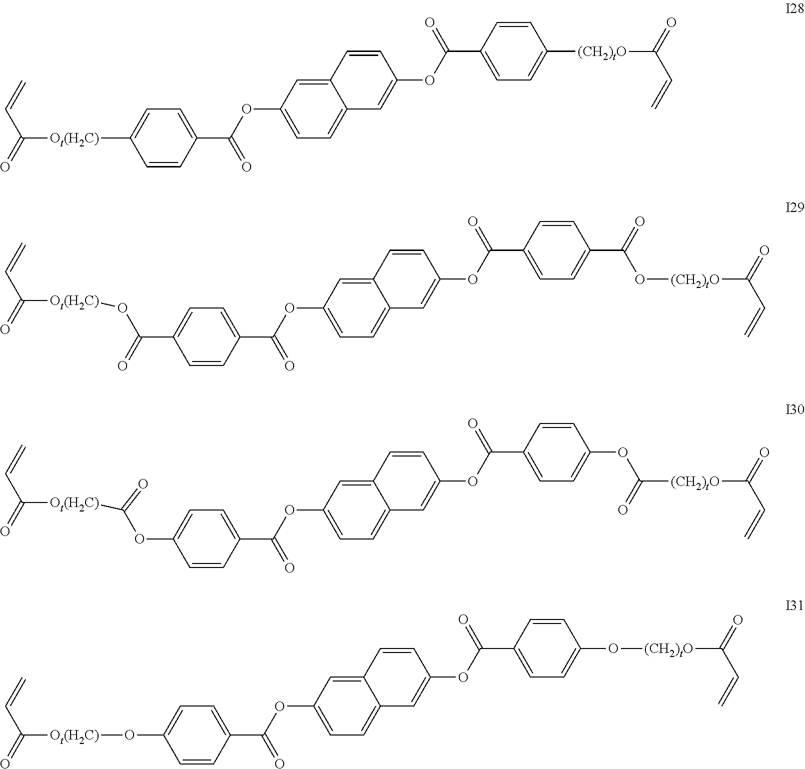

Wherein t and u each independently are 0, 1, 2, 3, 4, 5, 6, 7, 8. The compounds of formula I 4 to I 10, formula I 12 to I 15, formula I 17, formula I 19, formula I 21, formula I 23, formula I 25, formula I 27, formula I 29, and formula I 30 are preferred according to the solubility and compatibility of the above compounds and the safety criteria.

Further preferably, the above preferred compounds are specifically selected from the group consisting of compounds represented by the following formula I 4-1 to formula I 30-1:

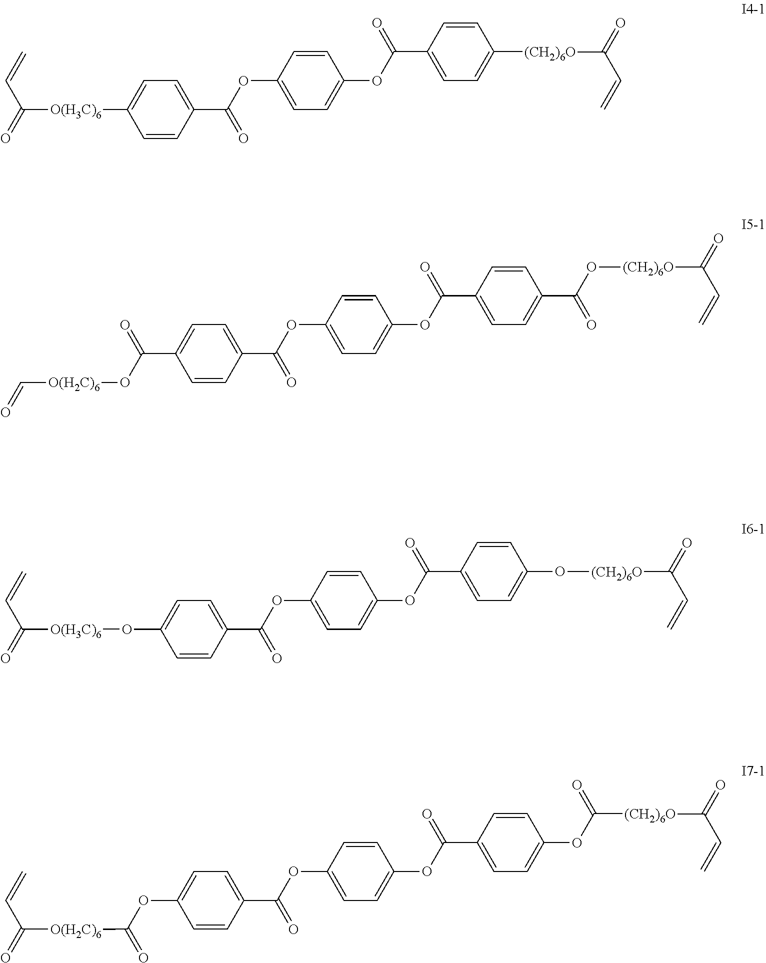

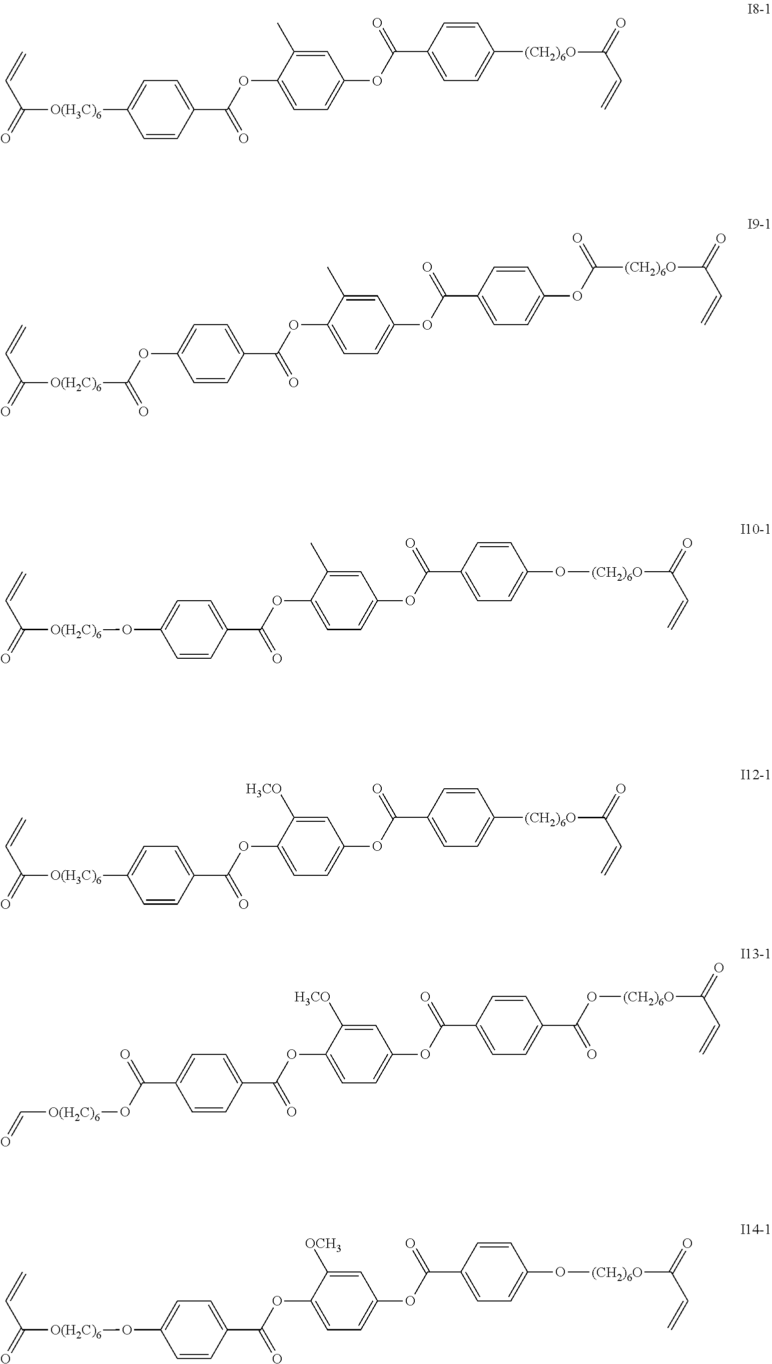

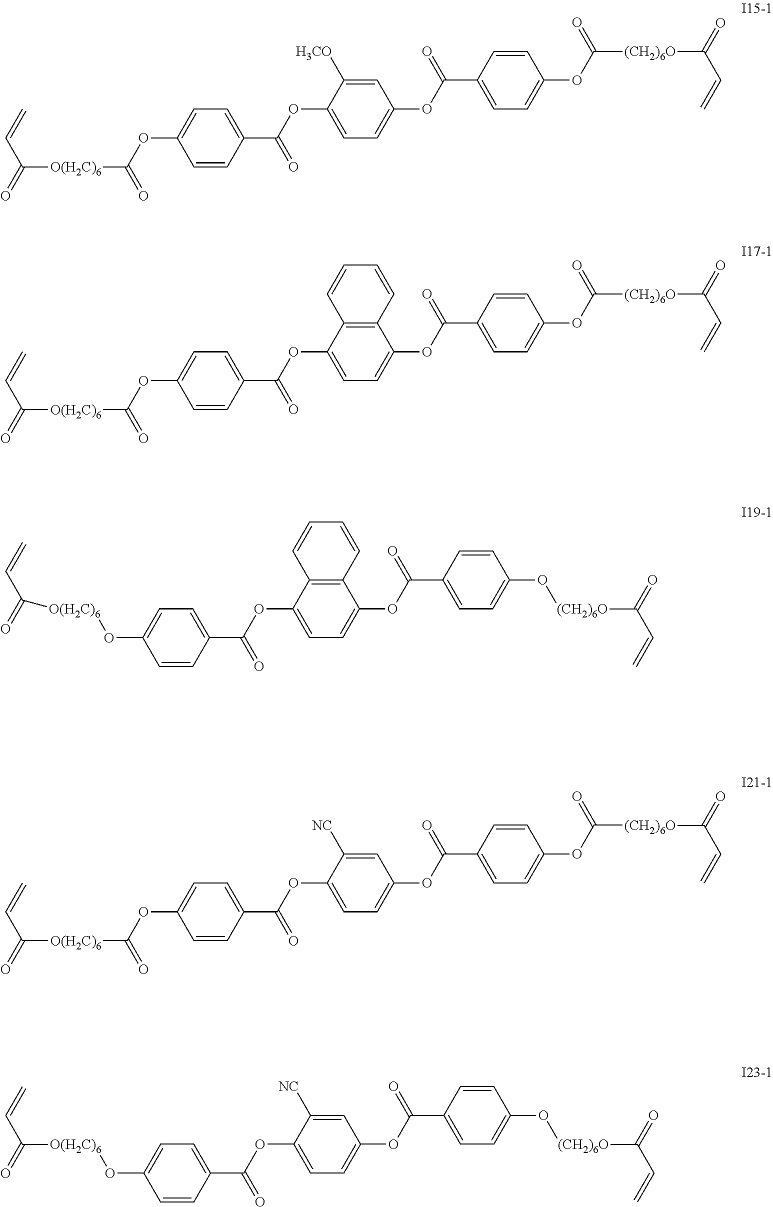

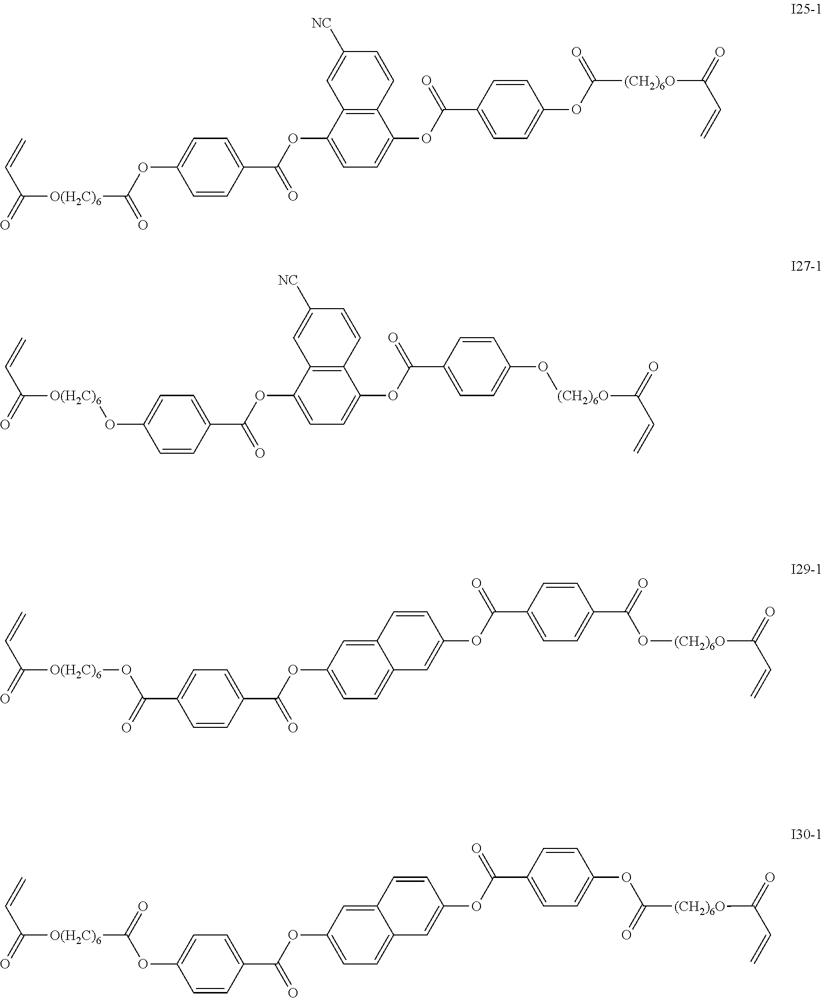

More preferably, the further preferred compound is selected from the group consisting of formula I 6-3, formula I 7-3, formula I 10-3, formula I 14-3, formula I 15-3, formula I 19-3, formula I 21-3, formula I 23-3, formula I 27-3, formula I 29-3, and formula I 30-3.

The polymerizable composition of the present disclosure further comprises one or more compounds of formula II,

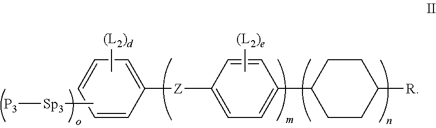

In the formula II, R represents a polymerizable group, H, or a linear alkyl group having 1 to 25 carbon atoms or a branched or cyclic alkyl group having 3 to 25 carbon atoms, wherein one or more non-adjacent —CH₂— groups are optionally substituted by —O—, —S—, —CO—, —CO—O—, —O—CO—, —O—CO—O—, —N— in such a way that the —O— or —S— atoms are not directly bonded to each other, wherein one or more H atoms are each optionally substituted by a halogen or a methyl group;

Z each independently represents a single bond, an alkyl group having 1 to 10 carbon atoms, or an alkenyl group having 2 to 10 carbon atoms, wherein any H atom may be substituted by fluorine, and any one or more unconnected —CH₂-groups may be substituted by —O—, —S—, —COO—, or —OOC—;

L₂ and L₃ each independently represents H, F, Cl, —CN, or a linear alkyl group having 1 to 25 carbon atoms, a branched or cyclic alkyl group having 3 to 25 carbon atoms, an alkenyl group having 2 to 25 carbon atoms, or an alkynyl group having 2 to 25 carbon atoms; wherein one or more non-adjacent —CH₂— groups are optionally substituted by —O—, —S—, —CO—, —CO—O—, —O—CO—, —O—CO—O—, —N— in such a way that the —O— or —S— atoms are not directly bonded to each other, wherein one or more H atoms are each optionally substituted by halogen;

Sp₃ represents a spacer;

P₃ each independently represents a polymerizable group or H;

d, e, f, and g each independently represents 0, 1, 2, 3, or 4;

m and n each independently represents 0, 1, 2, and m+n≥1;

o and h each independently represents 1, 2, 3.

Preferably, the compound of formula II is selected from the group consisting of compounds of formula II1-II37,

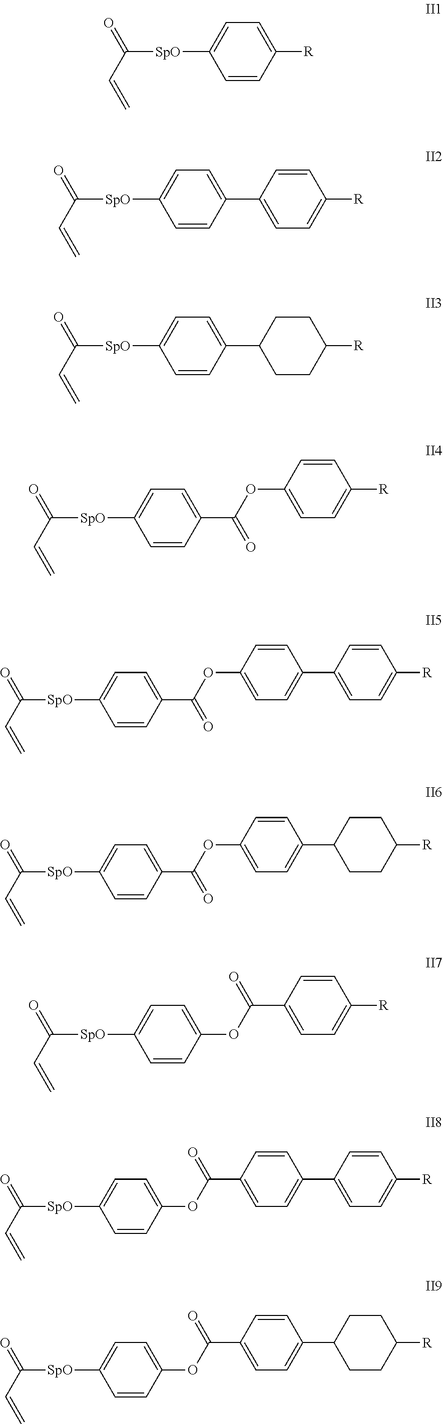

Sp represents a spacer,

R represents a polymerizable group, a single bond, an alkyl group having 1 to 10 carbon atoms, an alkoxy group having 1 to 10 carbon atoms, a fluorine-substituted alkoxy group having 1 to 10 carbon atoms, an alkenyl group having 2 to 10 carbon atoms, a fluorine-substituted alkenyl group having 2 to 10 carbon atoms, an alkenyloxy group having 3 to 8 carbon atoms or a fluorine substituted alkenyloxy group having 3 to 8 carbon atoms, an alkynyl group having 2 to 10 carbon atoms, a fluorine substituted alkynyl group having 2 to 10 carbon atoms, an alkynyl group having 2 to 8 carbon atoms or a fluorine substituted alkynyl group having 3 to 8 carbon atoms, and any one or more unconnected —CH₂— in the groups represented by R may each independently be optionally substituted by —O—, —S—, —COO—, —OOC—.

Furthermore, the preferred compounds are specifically selected from the group consisting of compounds represented by the following formula III-1 to formula II9-1:

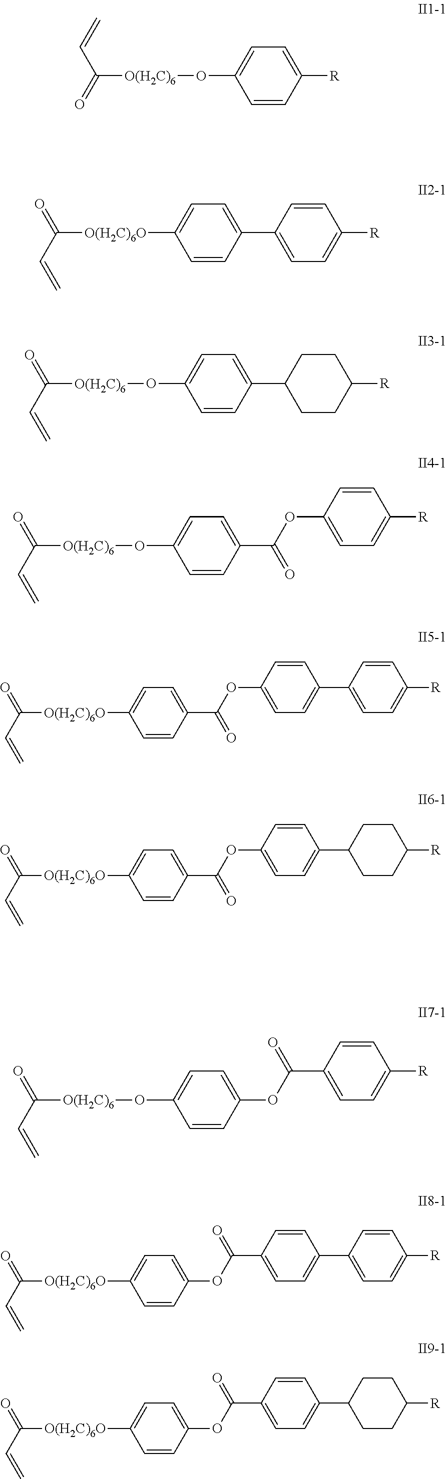

Wherein, R represents a polymerizable group, a single bond, an alkyl group having 1 to 10 carbon atoms, an alkoxy group having 1 to 10 carbon atoms, a fluorine substituted alkoxy group having 1 to 10 carbon atoms, an alkenyl group having 2 to 10 carbon atoms, a fluorine substituted alkenyl group having 2 to 10 carbon atoms, an alkenyloxy group having 3 to 8 carbon atoms or a fluorine substituted alkenyloxy group having 3 to 8 carbon atoms, an alkynyl group having 2 to 10 carbon atoms, a fluorine substituted alkynyl group having 2 to 10 carbon atoms, an alkynyl group having 2 to 8 carbon atoms or a fluorine substituted alkynyl group having 3 to 8 carbon atoms, and any one or more unconnected —CH₂— in the groups represented by R may each independently be optionally substituted by —O—, —S—, —COO—, —OOC—.

More preferably, the further preferred compound represented by the formula IV is selected from the group consisting of compounds represented by the formula II1-10 a1 to compounds represented by the formula II 25-13 a2,

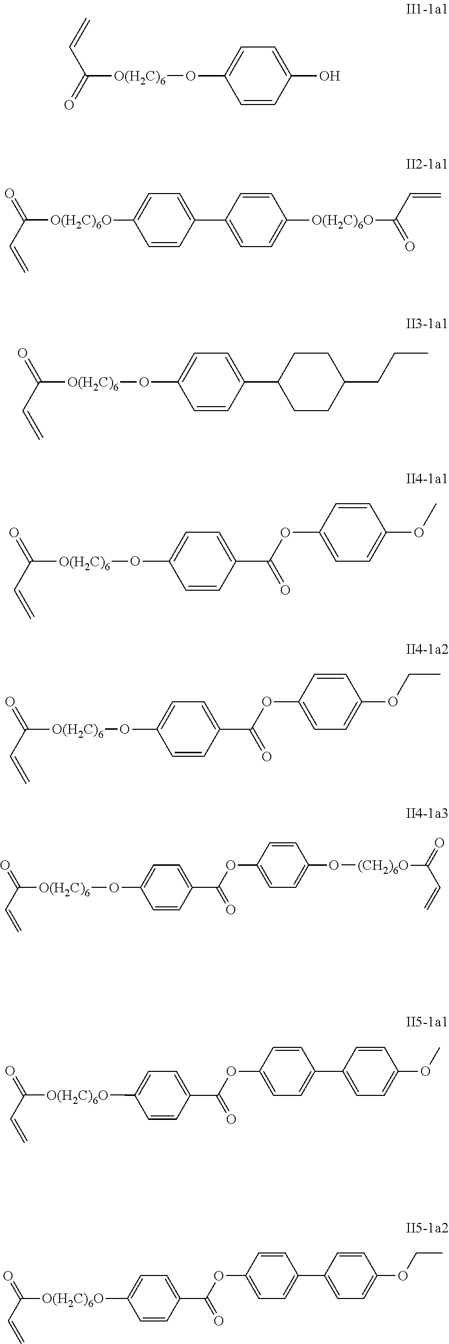

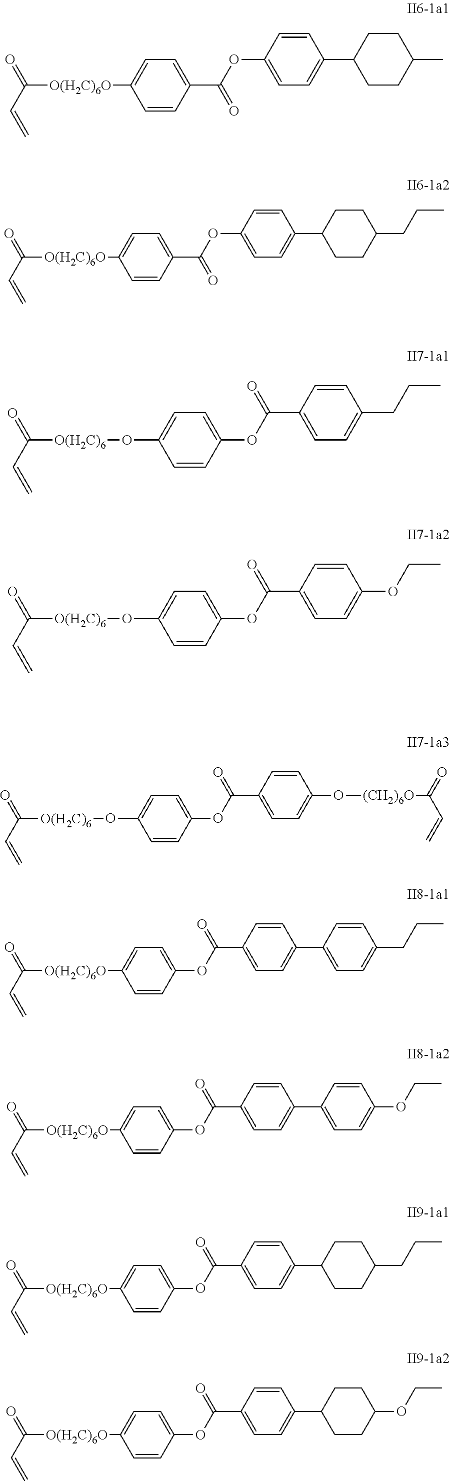

The polymerizable compositions described herein further comprise one or more compounds of formula VI or formula V,

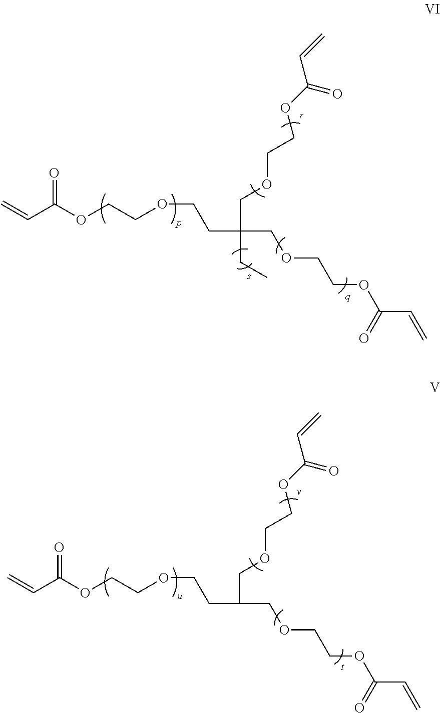

In the formula VI and V,

The hydrogen in the methyl group may be each independently substituted by F, Cl, —CN, or a linear alkyl group having 1 to 25 carbon atoms, branched or cyclic alkyl group having 3 to 25 carbon atoms;

p, q, r, t, u, and v each independently represents an integer of 1 to 4;

S represents 0, 1, 2, 3.

In the polymerizable composition of the present disclosure, the one or more compounds represented by formula VI-1 and formula V4 are preferably selected from the group consisting of formula VI-1 to formula V4, but are not limited to the following compounds:

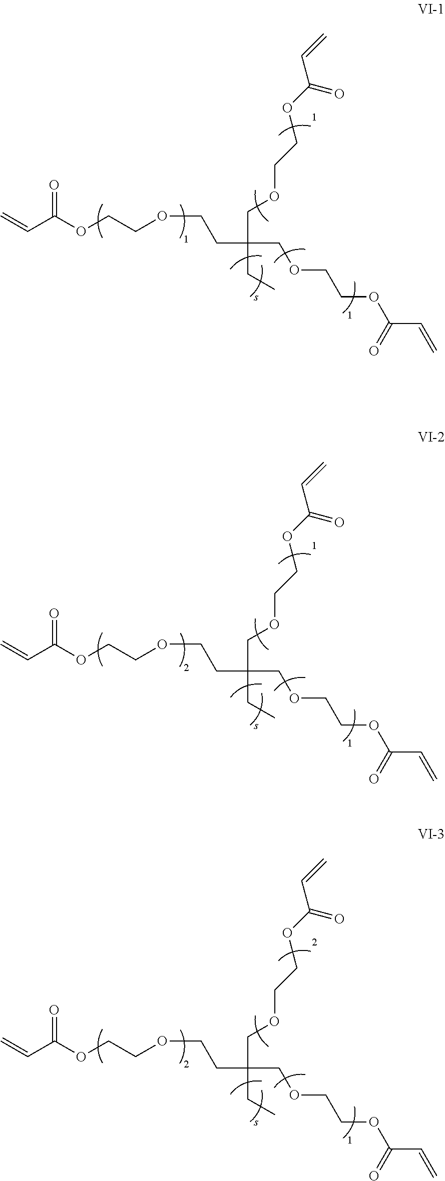

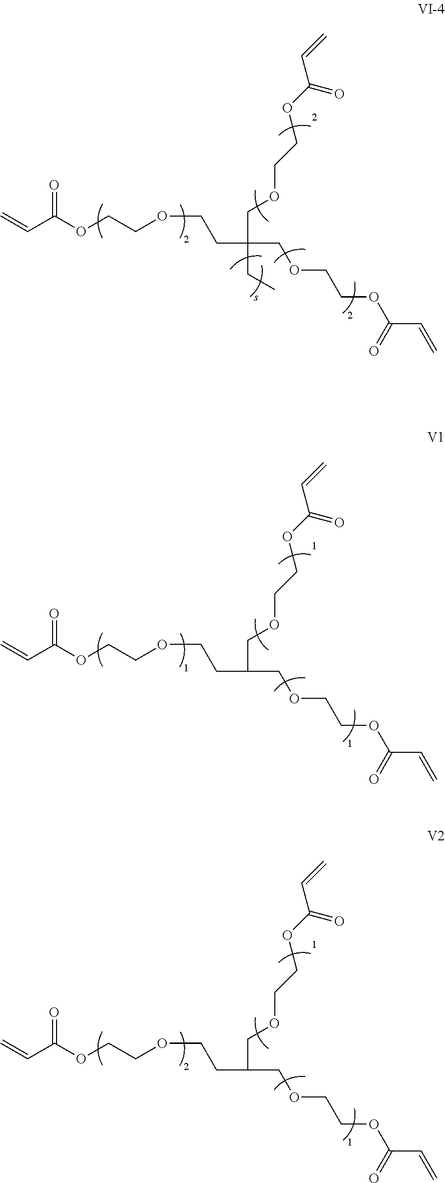

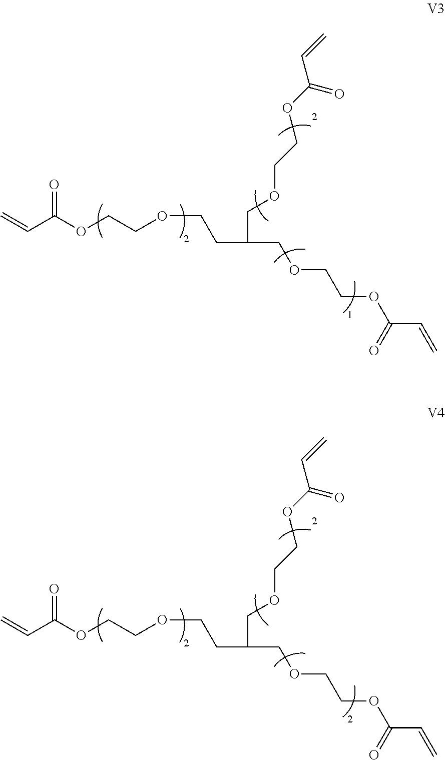

S represents 0, 1, 2, 3.

Preferably, the one or more compounds represented by formula VI-1 and formula V4 are selected from the group consisting of formula VI-1 to formula V4, but are not limited to the following compounds;

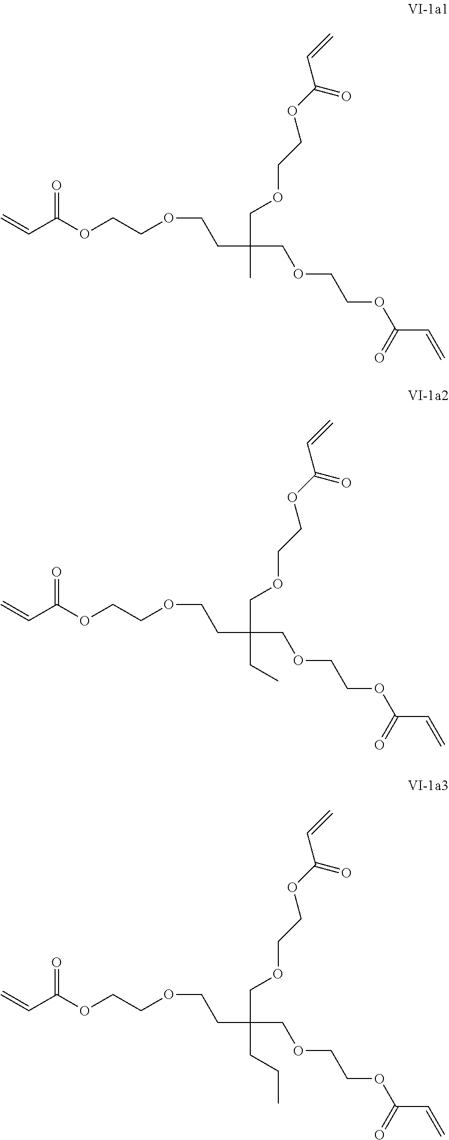

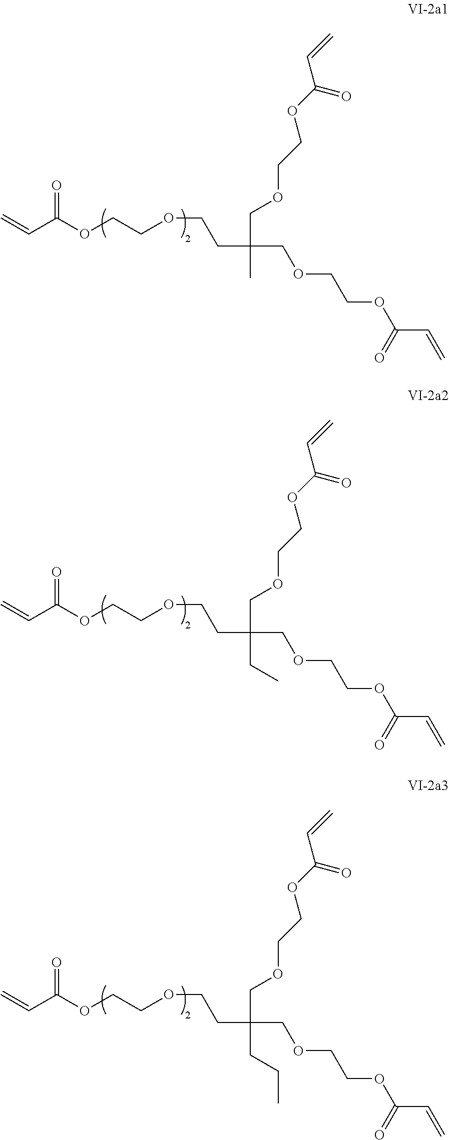

As a preferred example, the compounds represented by formula I and formula II are preferably compounds represented by the following formula.

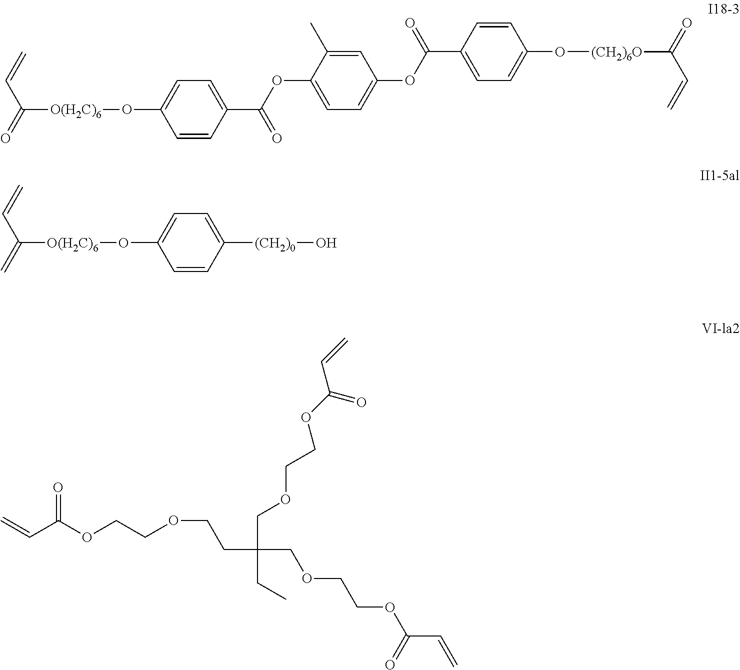

The structure of the single polymerized liquid crystal compound is as follows:

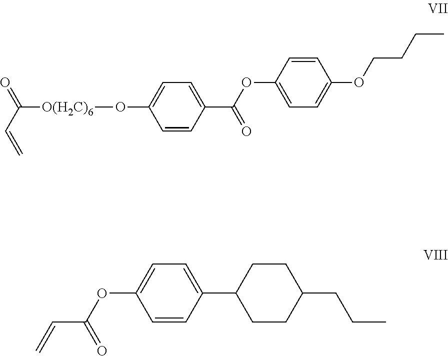

Chiral agent: LC756

MIBK: methyl isobutyl ketone.

The example of the present application also discloses another polymerizable composition, and the disclosed polymerizable composition is contained in a C film formed by a positive dispersion type rod-shaped liquid crystal, wherein the C film is the C film described above.

The polymerizable composition comprises: an acrylic resin, a first material and a second material, wherein the first material comprises a compound with a formula I, and the second material comprises a compound with a formula IV and/or a compound with a formula III;

Formula I is as follows:

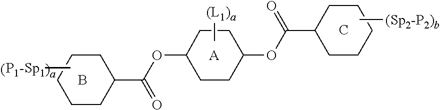

Wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula I,

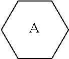

comprise any one of 1,4-cyclohexylene, 1,4-phenylene, 2,6-naphthylene, 1,5-naphthylene, and 1,4-naphthylene;

In the formula I,

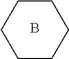

comprise any one of 1,4-cyclohexylene, 1,4-phenylene, 2,6-naphthylene, 1,5-naphthylene, and 1,4-naphthylene;

In the formula I,

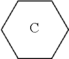

comprise any one of 1,4-cyclohexylene, 1,4-phenylene, 2,6-naphthylene, 1,5-naphthylene, and 1,4-naphthylene;

Sp₁ is a spacer, Sp₂ is a spacer;

P₁ comprises a polymerizable group or H, P₂ comprises a polymerizable group or H, and at least one of P₁ and P₂ is a polymerizable group;

a is 1, 2 or 3; b is 1, 2 or 3; b is 1, 2 or 3;

Formula IV is as follows:

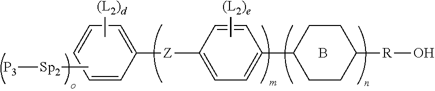

Formula III is as follows:

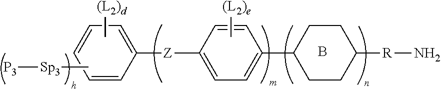

In the formula IV and the formula III, R comprises any one of H, a linear chain alkyl group having 1 to 25 carbon atoms, a branched chain alkyl group having 3 to 25 carbon atoms, and a cyclic alkyl group having 3 to 25 carbon atoms;

Z comprises any one of a single bond, an alkyl group having 1 to 10 carbon atoms, and an alkenyl group having 2 to 10 carbon atoms;

L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

L₃ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;

In the formula IV and in the formula III,

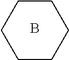

comprises any one of an aryl group, a heteroaryl group, an alicyclic group, a heterocyclic group and a fused ring;

Sp₃ is a spacer;

P₃ comprises a polymerizable group or H;

d is 0, 1, 2, 3 or 4;

e is 0, 1, 2, 3 or 4;

f is 0, 1, 2, 3 or 4;

g is 0, 1, 2, 3 or 4;

m is 0, 1 or 2, n is 0, 1 or 2, and m+n≥1;

o is 1, 2 or 3 and h is 1, 2 or 3.

Preferably, the aforementioned compound of formula I is preferably selected from the group consisting of I 1 to I 31,

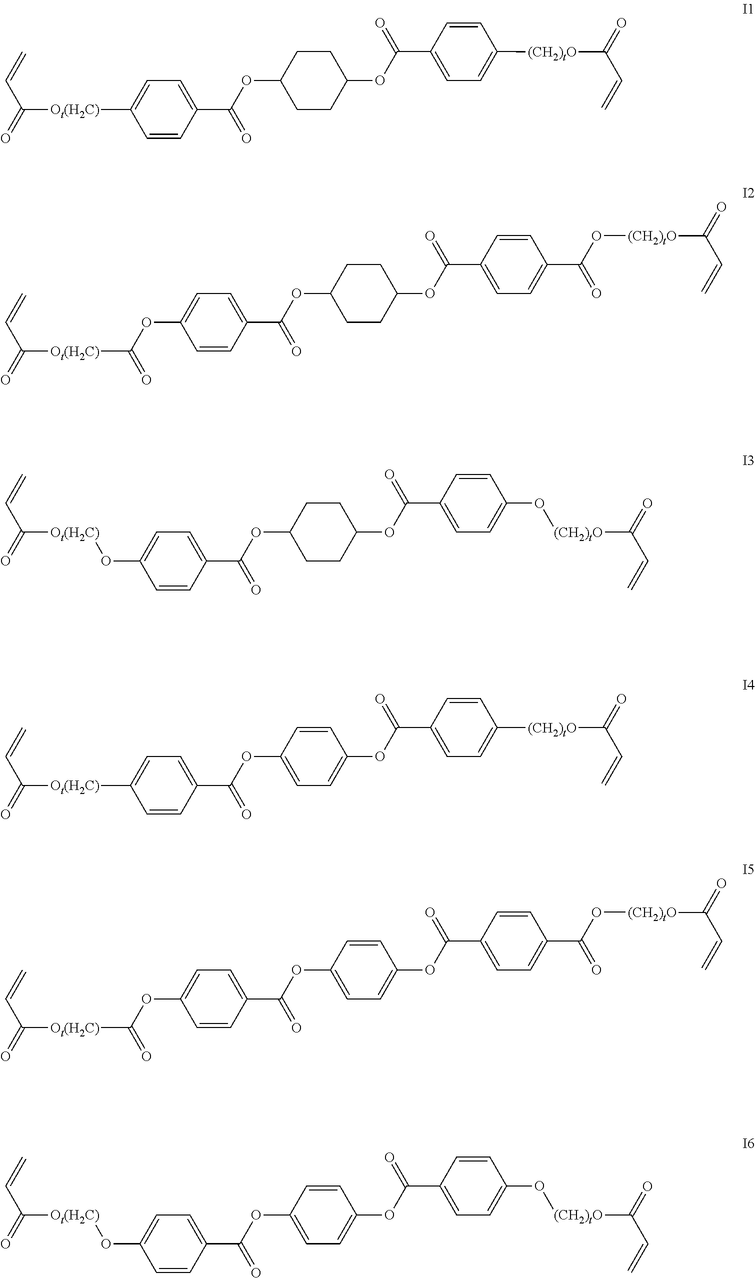

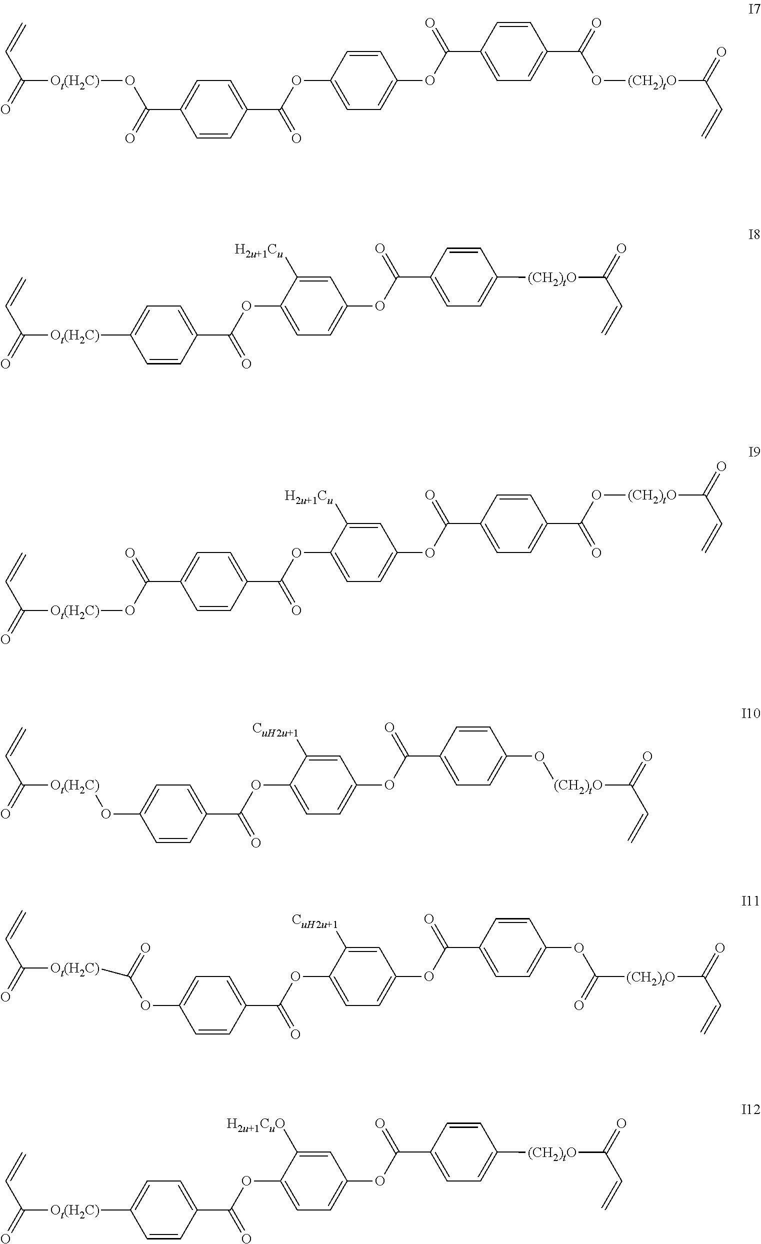

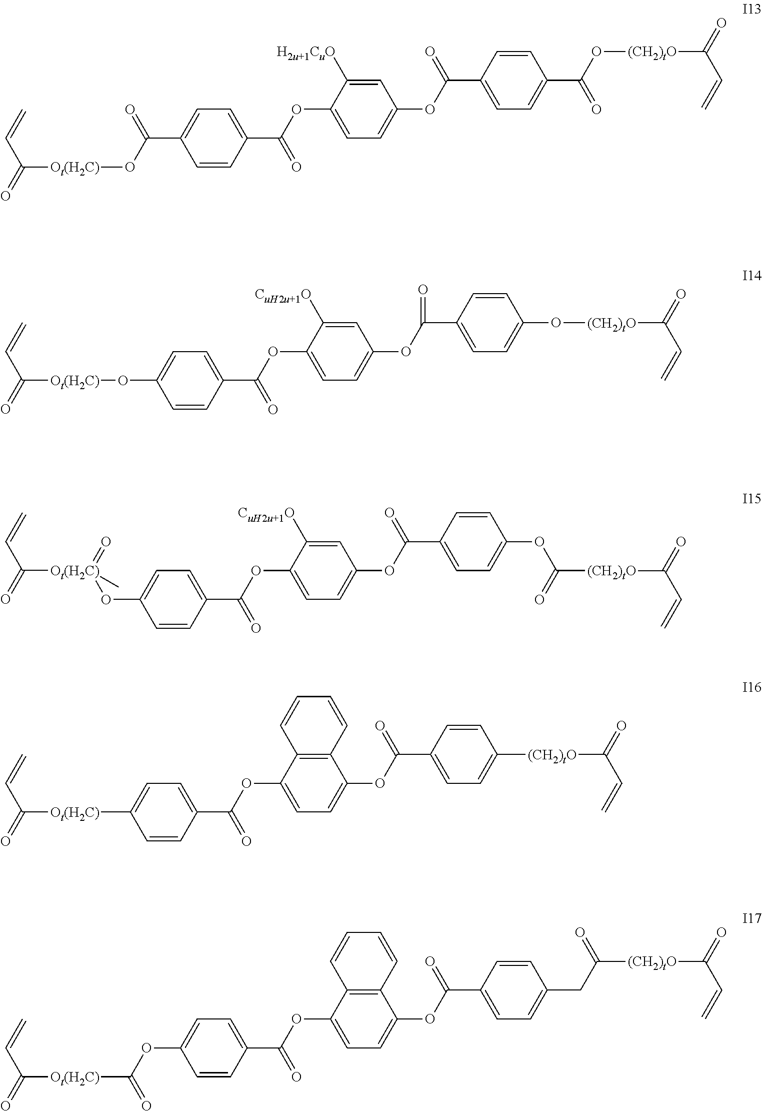

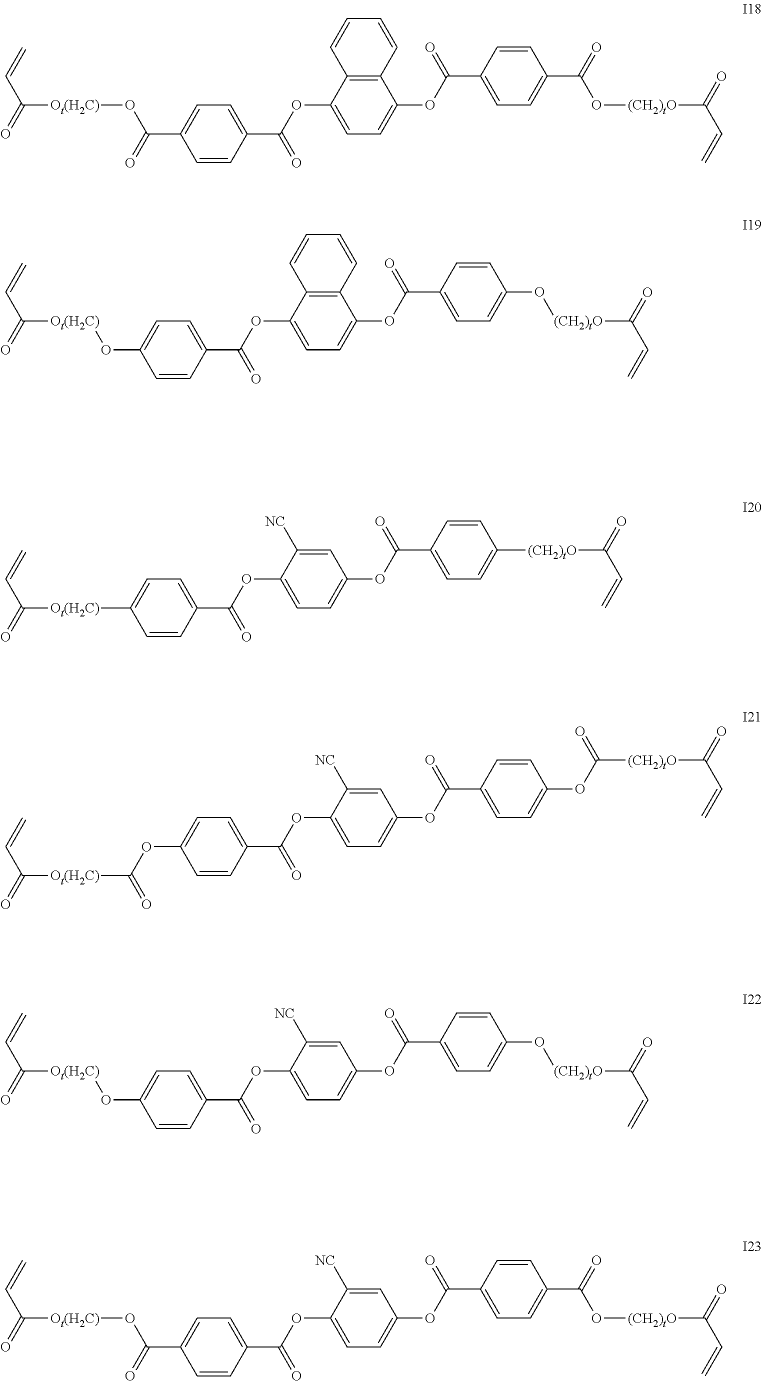

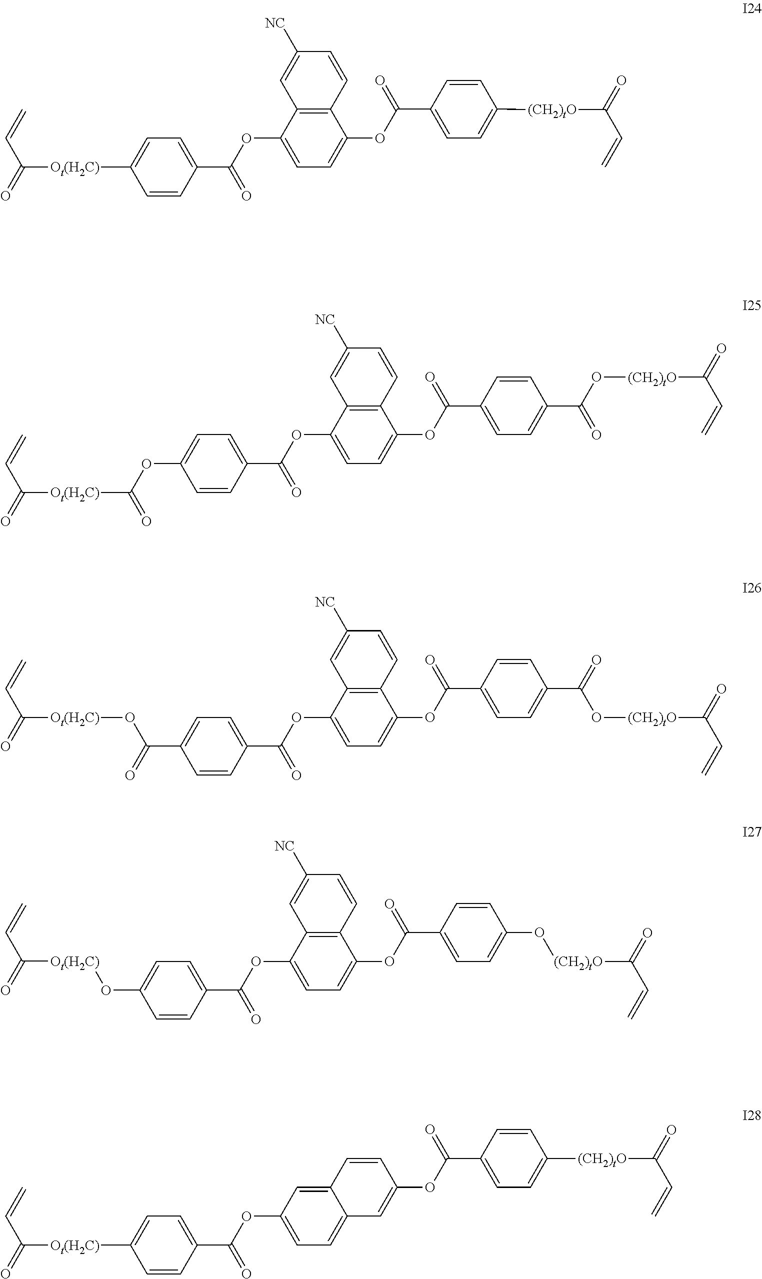

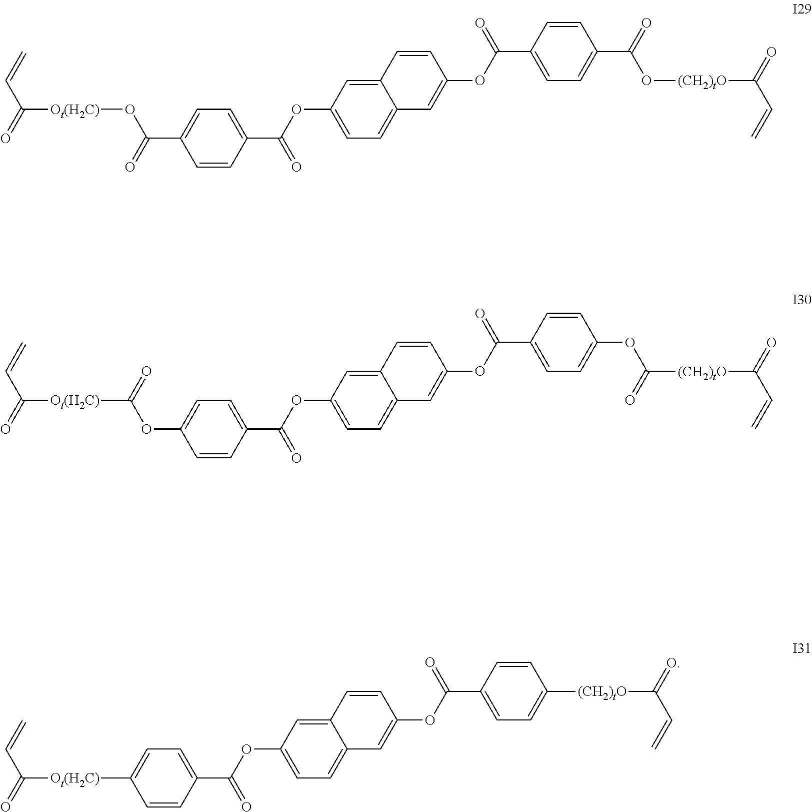

Wherein t and u each independently is 0, 1, 2, 3, 4, 5, 6, 7, 8. The compounds of formula I 4 to I 10, formula I 12 to I 15, formula I 17, formula I 19, formula I 21, formula I 23, formula I 25, formula I 27, formula I 29, and formula I 30 are preferred according to the solubility and compatibility of the above compounds and the safety criteria.

Further preferably, the above preferred compounds are specifically selected from the group consisting of compounds represented by the following formula I 4-1 to formula I 30-3:

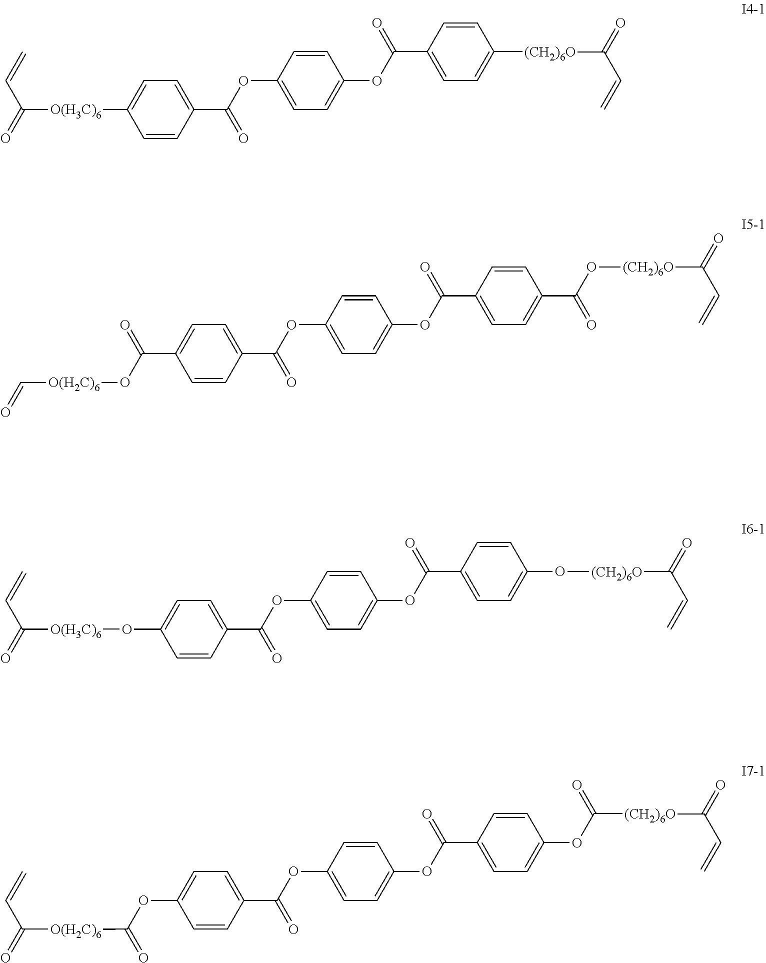

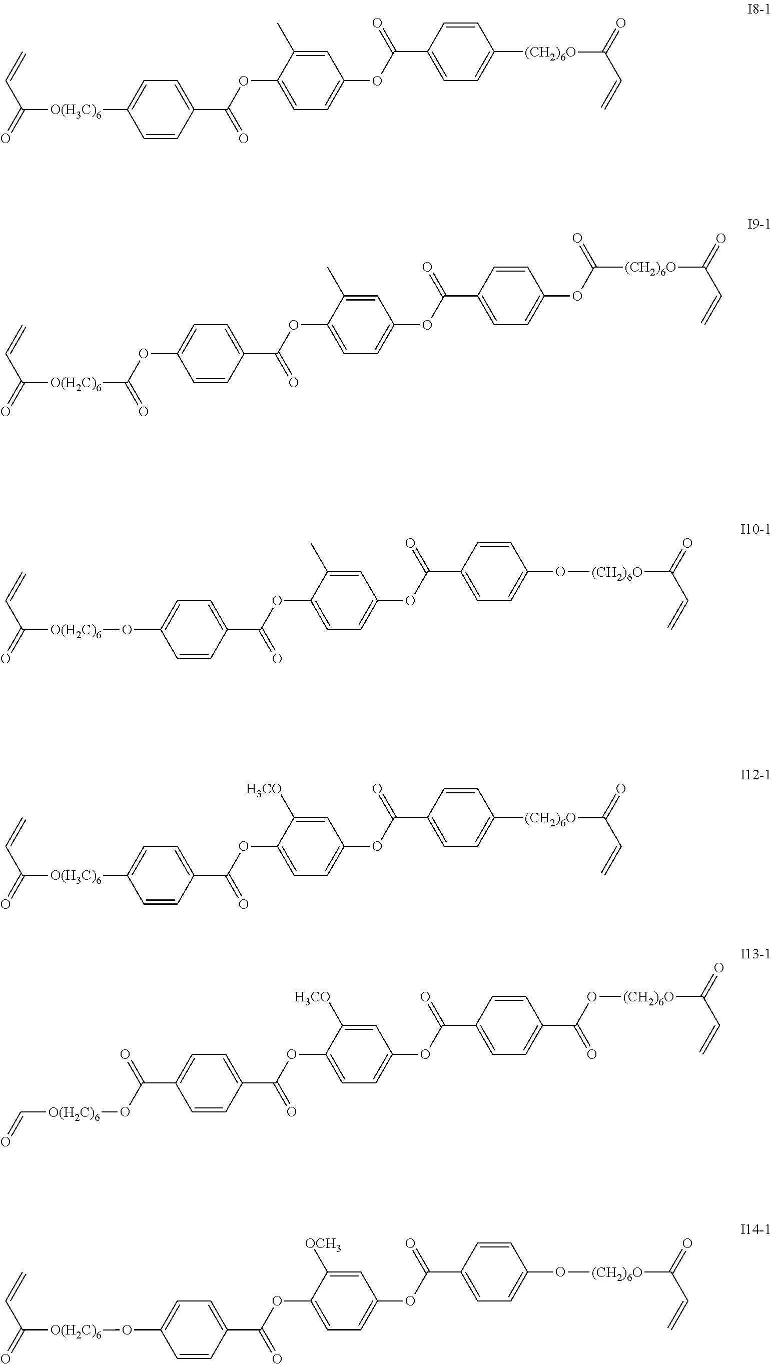

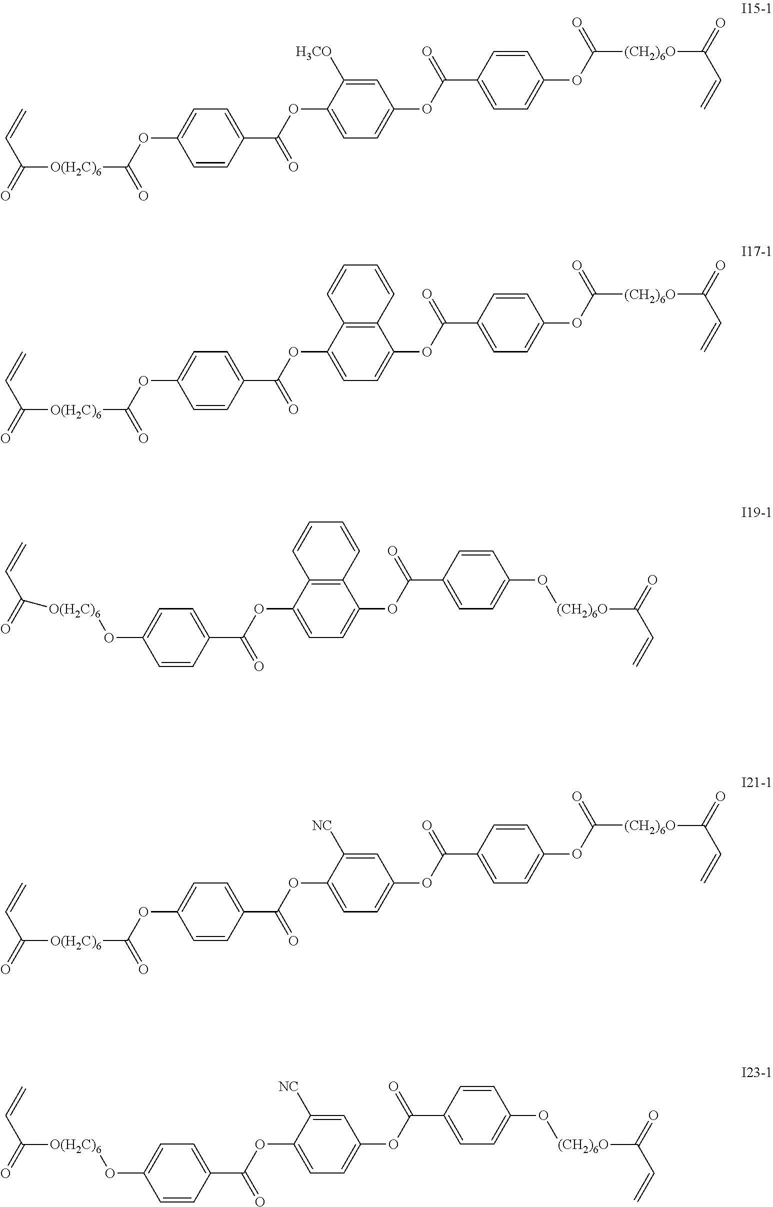

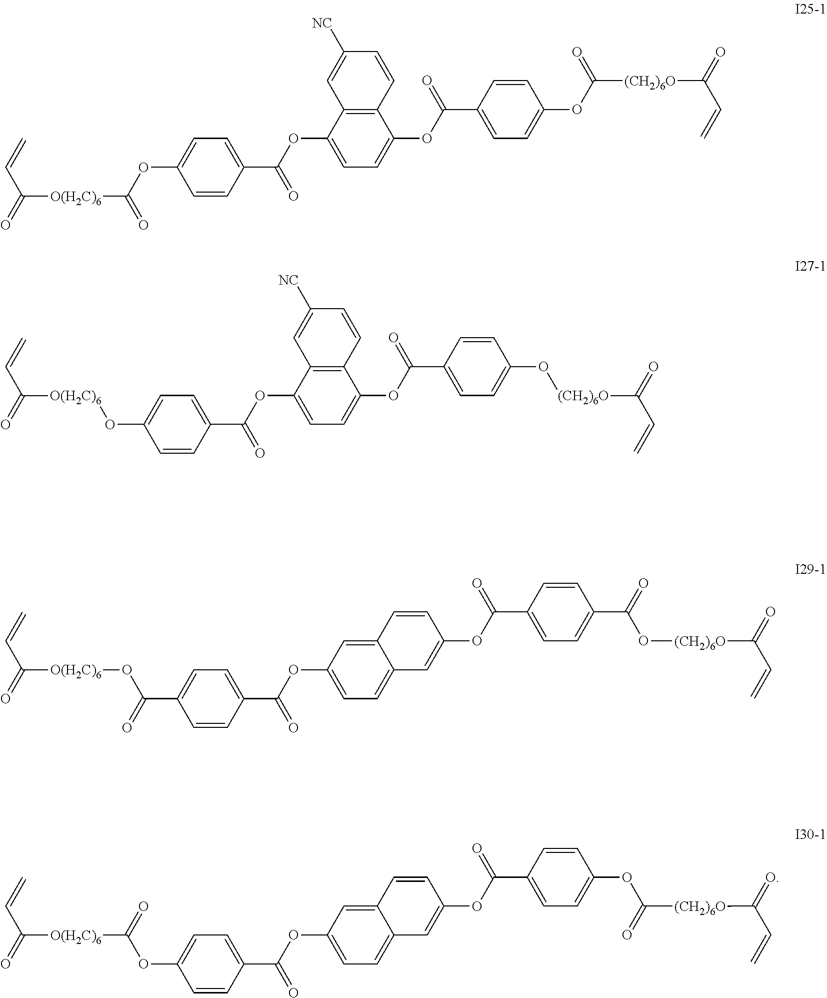

More preferably, the aforementioned further preferred compound is selected from the group consisting of formula I 6-3, formula I 7-3, formula I 10-3, formula I 14-3, formula I 15-3, formula I 19-3, formula I 21-3, formula I 23-3, formula I 27-3, formula I 29-3, and formula I 30-3.

The polymerizable composition of the present disclosure further comprises one or more compounds of formula IV and/or formula III,

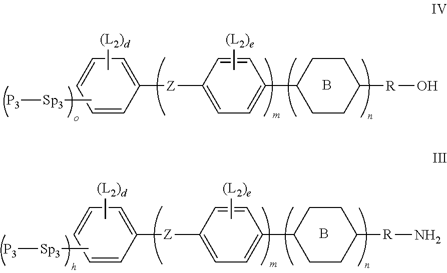

In the formula IV and III,

R represents H or a linear chain, branched chain or cyclic alkyl group having a carbon number of 1 to 25, wherein one or more nonadjacent —CH₂— groups are optionally substituted by —O—, —S—, —CO—, —CO—O—, —O—CO—, —O—CO—O—, —N— in such a way that the —O— or —S— atoms are not directly bonded to each other, wherein one or more H atoms are each optionally substituted by a halogen or a methyl group;

Z each independently represents a single bond, an alkyl group having 1 to 10 carbon atoms, or an alkenyl group having 2 to 10 carbon atoms, wherein any one H atom may be substituted by a fluorine, and any one or more unconnected —CH₂-groups may be optionally substituted by —O—, —S—, —COO—, or —OOC—;

L₂ and L₃ each independently represents H, F, Cl, —CN, or a linear, branched, or cyclic alkyl group having 1 to 25 carbon atoms, an alkenyl group having 2 to 25 carbon atoms, or an alkynyl group having 2 to 25 carbon atoms; wherein one or more non-adjacent —CH₂— groups are optionally substituted by —O—, —S—, —CO—, —CO—O—, —O—CO—, —O—CO—O—, —N— in such a way that the —O— or —S— atoms are not directly bonded to each other, wherein one or more H atoms are each optionally substituted by halogen;

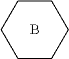

represents an aryl, heteroaryl, alicyclic, or heterocyclic group, may also comprise a fused ring and is optionally mono-substituted or poly-substituted by L₆;

L₆ each independently represents H, F, Cl, —CN, or a linear, branched, or cyclic alkyl group having 1 to 25 carbon atoms, an alkenyl group having 2 to 25 carbon atoms, or an alkynyl group having 2 to 25 carbon atoms; wherein one or more non-adjacent —CH₂— groups are optionally substituted by —O—, —S—, —CO—, —CO—O—, —O—CO—, —O—CO—O—, —N— in such a way that the —O— or —S— atoms are not directly bonded to each other, wherein one or more H atoms are each optionally substituted by halogen;

Sp₃ represents a spacer;

P₃ each independently represents a polymerizable group or H;

d, e, f, and g each independently represents 0, 1, 2, 3, or 4;

m and n each independently represents 0, 1, 2, and m+n≥1;

o and h each independently represents 1, 2, 3.

Preferably, the compound of formula IV is selected from the group consisting of compounds with formula IV1 to IV37:

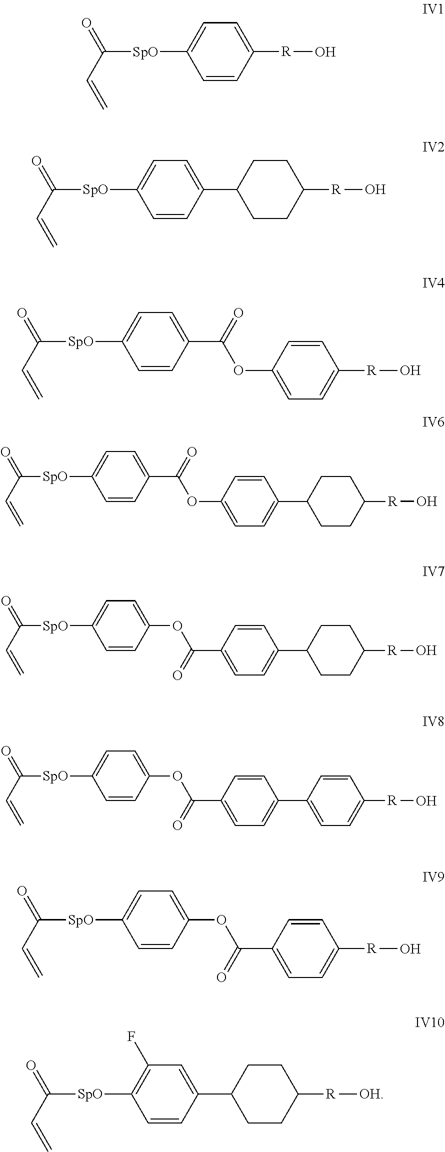

Preferably, the compound of formula III is selected from the group consisting of compounds with formula III1-III37:

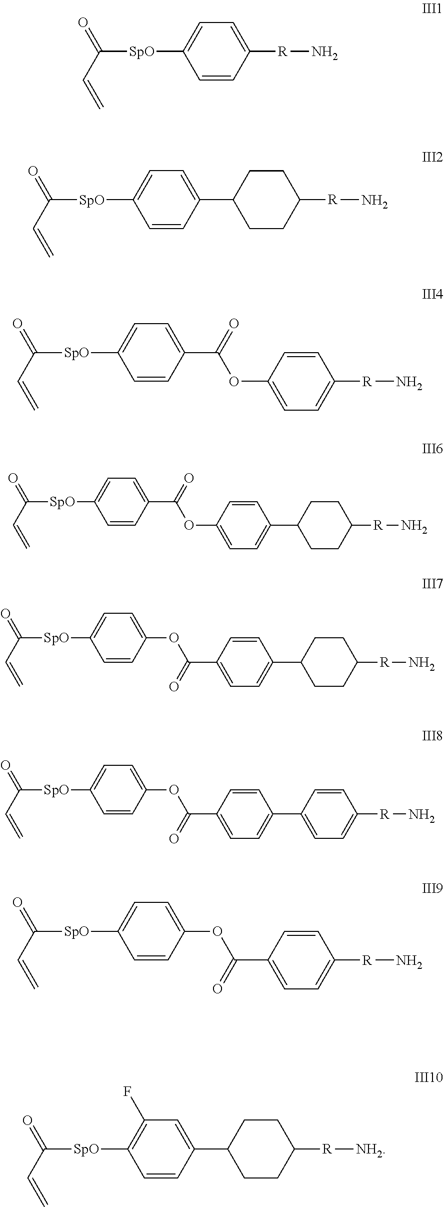

The F atom in the compound shown above may be independently substituted by a Cl atom, a methyl group, or a methoxy group;

Sp represents a spacer;

R represents a single bond, an alkyl group having 1 to 10 carbon atoms, an alkoxy group having 1 to 10 carbon atoms, a fluorine-substituted alkoxy group having 1 to 10 carbon atoms, an alkenyl group having 2 to 10 carbon atoms, a fluorine-substituted alkenyl group having 2 to 10 carbon atoms, an alkenyloxy group having 3 to 8 carbon atoms or a fluorine-substituted alkenyloxy group having 3 to 8 carbon atoms, an alkynyl group having 2 to 10 carbon atoms, a fluorine-substituted alkynyl group having 2 to 10 carbon atoms, an alkynyl group having 2 to 8 carbon atoms or a fluorine-substituted alkynyl group having 3 to 8 carbon atoms, and any one or more unconnected —CH₂— in the groups represented by R may each independently be optionally substituted by —O—, —S—, —COO—, —OOC—.

Furthermore, the aforementioned preferred compounds are specifically selected from the group consisting of compounds represented by the following formula IV1-1 to formula III9-1:

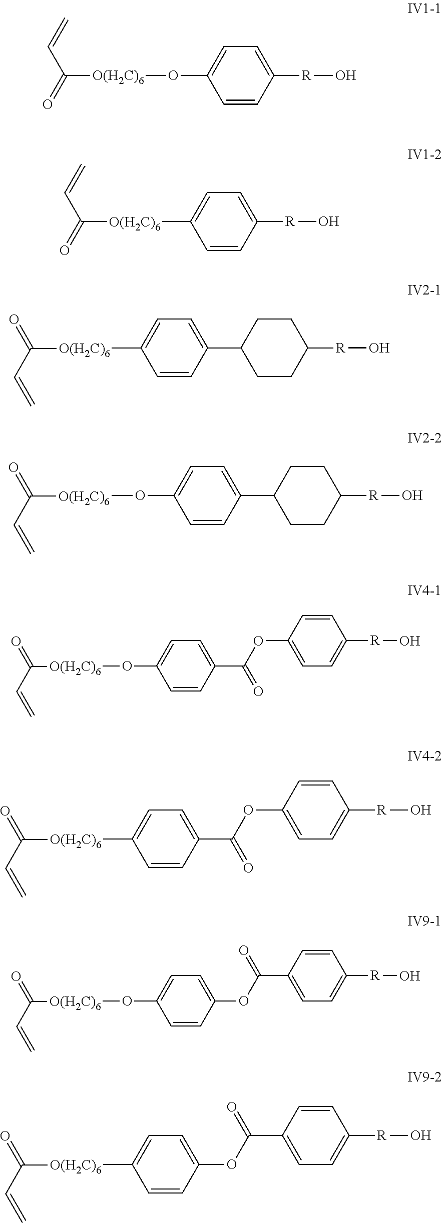

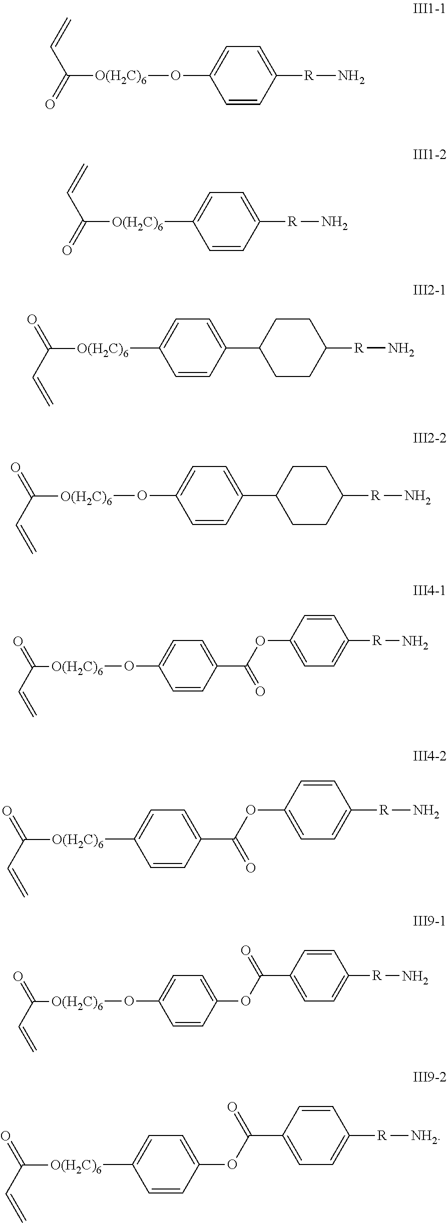

Wherein R represents a single bond, an alkyl group having 1 to 10 carbon atoms, an alkoxy group having 1 to 10 carbon atoms, a fluorine-substituted alkoxy group having 1 to 10 carbon atoms, an alkenyl group having 2 to 10 carbon atoms, a fluorine-substituted alkenyl group having 2 to 10 carbon atoms, an alkenyloxy group having 3 to 8 carbon atoms or a fluorine-substituted alkenyloxy group having 3 to 8 carbon atoms, an alkynyl group having 2 to 10 carbon atoms, a fluorine-substituted alkynyl group having 2 to 10 carbon atoms, an alkynyl group having 2 to 8 carbon atoms, or a fluorine-substituted alkynyl group having 3 to 8 carbon atoms, and any one or more unconnected —CH₂— in the groups represented by R may each independently be optionally substituted by —O—, —S—, —COO—, —OOC—.

Still more preferably, the aforementioned further preferred compounds with the formula IV and III are specifically selected from the group consisting of the compounds with the formula:

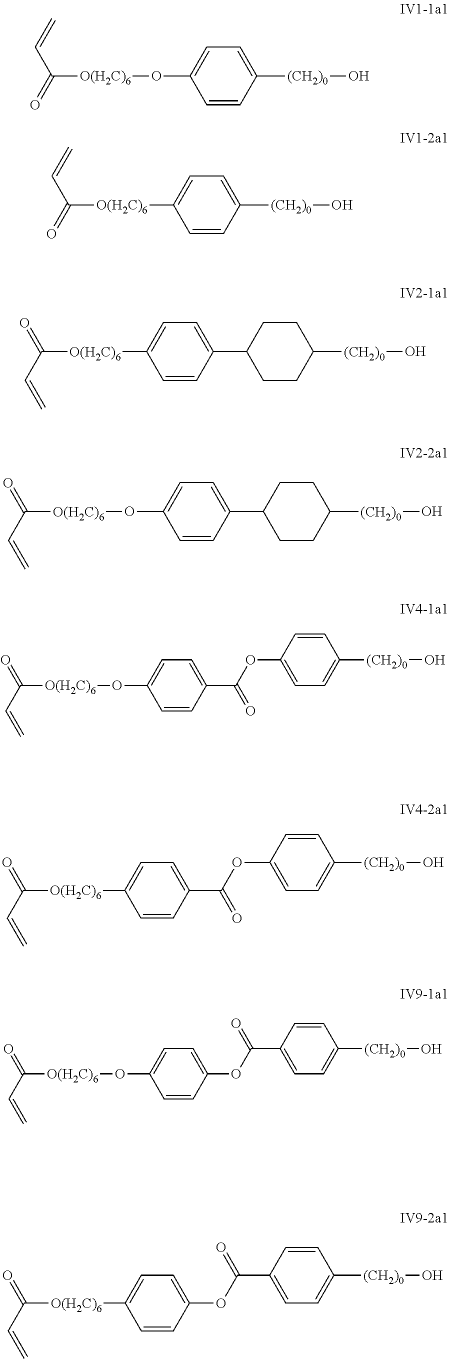

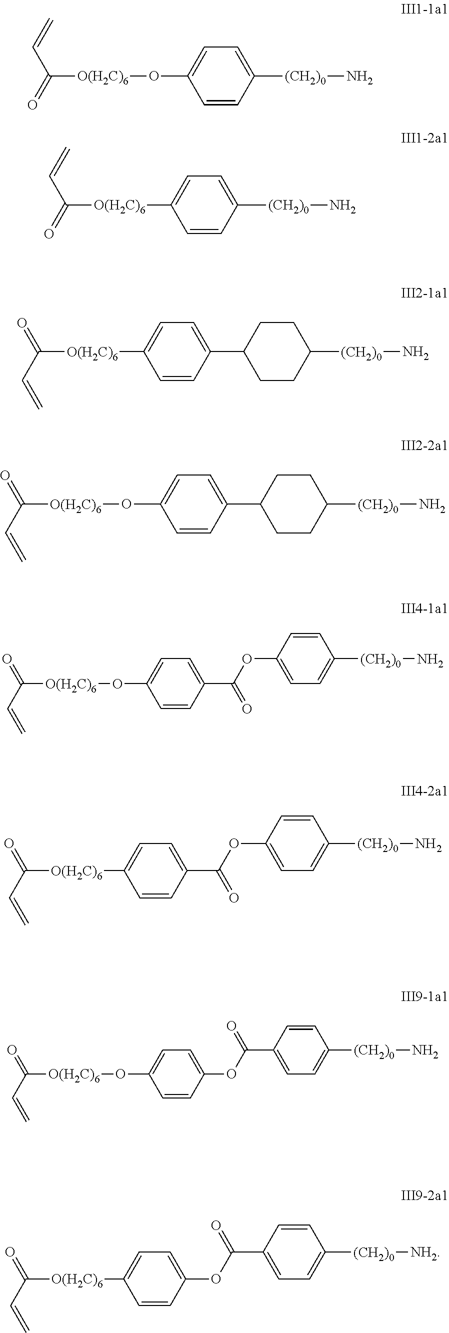

As a preferred example, the compounds of formula I, formula IV, formula III, formula VI and formula V are preferably those of the following formula:

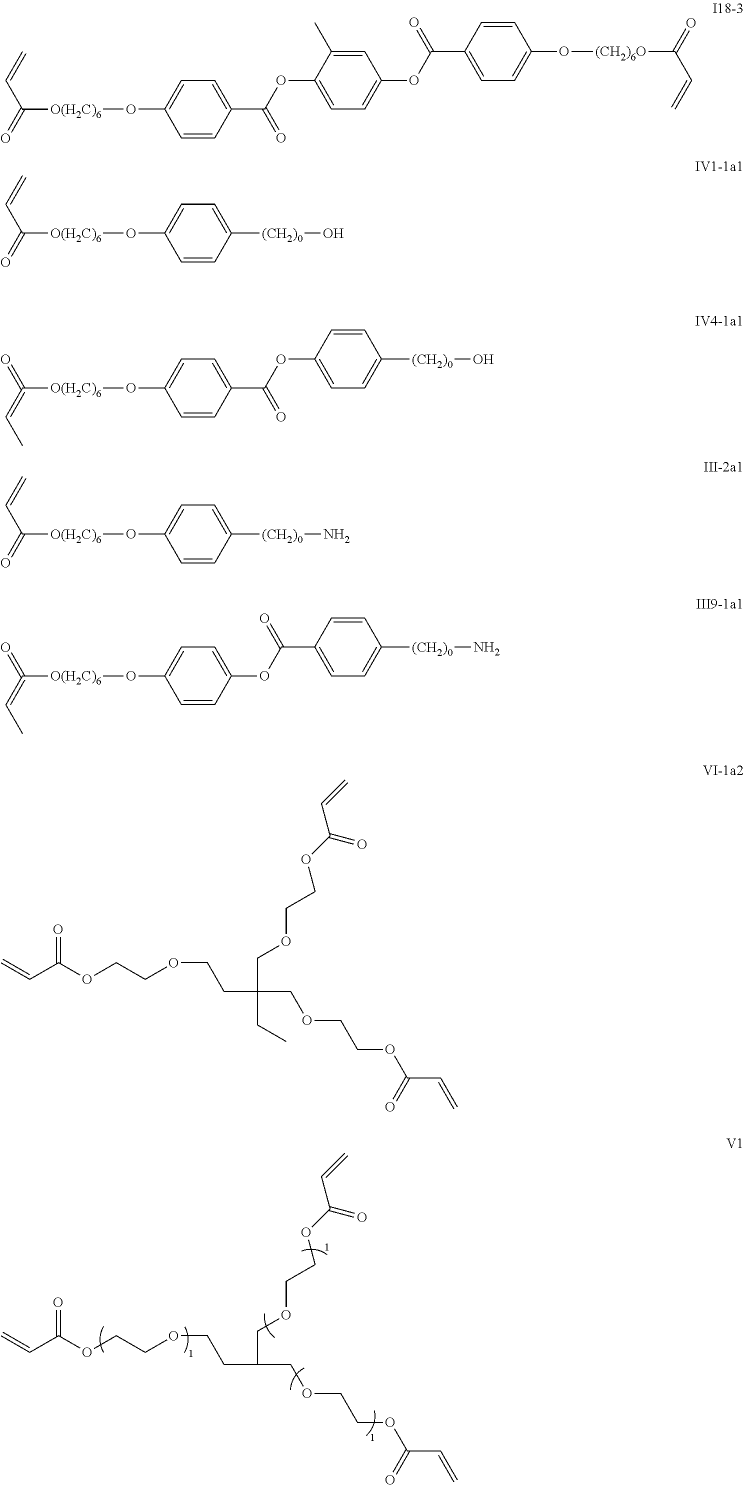

The structure of the single polymerized liquid crystal compound is as follows:

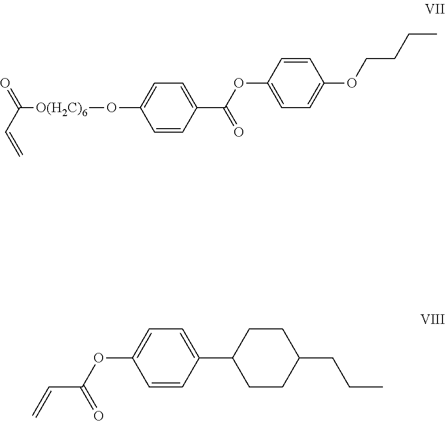

MIBK: methyl isobutyl ketone.

Based on the phase difference film, the example of the application is used for preparing the phase difference film, wherein the preparation method comprises the following steps:

Treating substrate 400;

Coating an alignment layer on the substrate 400;

Coating a horizontally aligned liquid crystal layer on the alignment layer;

Coating a vertically aligned liquid crystal layer on the substrate;

A laminated structure is fabricated in accordance with the horizontally aligned liquid crystal layer, the vertically aligned liquid crystal layer, and the horizontally aligned liquid crystal layer to form a phase difference film.

As shown in FIG. 8, for example, two layers of spiral A film and one layer of C film are separately coated.

1) Treating substrate 400: the transmissivity of the substrate 400 may be great than 60%, preferably, the transmissivity of the substrate 400 is greater than 80%. The substrate 400 may not be subjected to the treatment, or may be subjected to the surface treatment comprising UVC treatment, plasma treatment, or corona treatment on the surface of the substrate 400 according to the upper layer structure coating conditions.

2) Preparing an alignment layer: the alignment layer should ensure that it can be peel from the substrate 400 in addition to providing an alignment force for the liquid crystal layer. Coating an alignment layer on the substrate 400, and then performing drying and UV exposure, so that the alignment layer has horizontally aligned capability for the upper layer structure, and it should be ensured that the liquid crystal molecules of the liquid crystal layer in contact with the alignment layer are oriented in a preset direction. The coating process can select one of a spin coating method, a knife coating method, a roller coating method and an extrusion die knife coating method.

In addition, the temperature range of the drying process may be 60° C.-150° C., preferably, the temperature may be between 80° C.-130° C.; the drying time may be 10 s to 600 s, preferably 30 s to 300 s. The UV exposure amount may be 1 mJ to 50 mJ, preferably, the UV exposure amount may be 5 mJ to 40 mJ, and the UV exposure angle should correspond to the upper layer structure design angle.

3) Coating a liquid crystal layer: coating a horizontally aligned liquid crystal layer on the alignment layer, and drying and curing the liquid crystal layer by UV, so that the liquid crystal molecules are aligned in the horizontal direction and the film is formed stably. The internal molecules in the horizontally aligned liquid crystal layer are gradually twisted and rotated in the horizontal direction from the side close to the alignment layer to the side far away from the alignment layer.

4) Coating a vertically aligned liquid crystal on substrate 400, and drying and curing the liquid crystal by UV, so that the liquid crystal is aligned in the vertical direction, and the film is formed stably. Wherein, the temperature in the drying process of the liquid crystal layer can be 50° C. to 150° C., preferably 60° C. to 130° C., the drying time is 10 s to 600 s, preferably 30 s to 300 s, the UV curing amount is 100 mJ to 20000 mJ, preferably 300 mJ to 15000 mJ; during UV curing, inert gas can be added to the atmosphere in a rotating manner, a nitrogen is preferred, and the concentration of the inert gas is more than 95%.

5) Laminate: after the preparation of the liquid crystal single film is completed, preparing a laminated structure according to the structures of the horizontally aligned liquid crystal, an adhesive layer, the vertically aligned liquid crystal layer, an adhesive layer, the horizontally aligned liquid crystal layer and the like.

In addition, an anisotropic, transparent adhesive film may be directly used as the adhesive layer, or a coating method may be used to provide adhesion.

Based on the above phase difference film, the example of the application is used for preparing the phase difference film, wherein the preparation method comprises the following steps:

Treating a substrate 400;

Coating an alignment layer on the substrate 400;

Coating a horizontally aligned liquid crystal layer on the alignment layer;

Coating an alignment layer and a horizontally aligned liquid crystal layer on the substrate 400;

Preparing a laminated structure according to the structures of the horizontally aligned liquid crystal layer and the alignment layer, the vertically aligned liquid crystal layer, the horizontally aligned liquid crystal layer, to form a phase difference film.

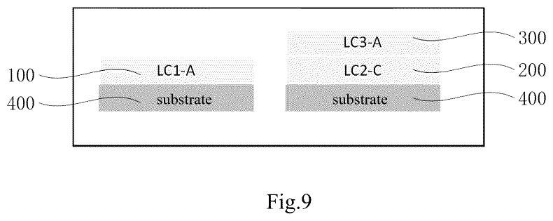

As shown in FIG. 9, for example, a layer of spiral A film, a layer of spiral A film and a layer of C film are coated.

1) Treating a substrate 400: the transmittance of the substrate 400 is great than 60%, preferably greater than 80%. The surface of the base material may not be treated, or may be treated according to the coating conditions of the upper layer structure, such as UVC treatment, plasma treatment, corona treatment, etc.

2) preparing an alignment layer: that alignment layer should ensure that it can be peeled from the substrate 400 in addition to providing an alignment force for the liquid crystal layer.

Coating an alignment layer on the substrate 400, and then performing drying and UV exposure, so that the alignment layer has horizontally aligned capability for the upper layer structure, and it should be ensured that the liquid crystal molecules of the liquid crystal layer in contact with the alignment layer are oriented in a preset direction.

The coating process may be one of a spin coating method, a knife coating method, a roller coating method, and an extrusion die knife coating method.

The temperature of the drying process is 60° C. to 150° C., preferably 80° C. to 130° C.; the drying time is 10 s to 600 s, preferably 30 s to 300 s; the UV exposure amount is 1 mJ to 50 mJ, preferably 5 mJ to 40 mJ; the UV exposure angle should correspond to the angle involved in the upper layer structure.

3) Coating a liquid crystal layer: coating a horizontally aligned liquid crystal layer on the alignment layer, and drying and curing the liquid crystal layer by UV, so that the liquid crystal molecules are aligned in the horizontal direction and the film is formed stably. The internal molecules in the horizontally aligned liquid crystal layer are gradually twisted and rotated in the horizontal direction from the side close to the alignment layer to the side far away from the alignment layer.

4) coating an alignment layer and a horizontally aligned liquid crystal layer on the substrate 400: the substrate 400 is coated with the alignment layer, and then performing drying and UV exposure to form a stable film; the alignment layer should not only provide alignment capability for the liquid crystal layer, but also contain vertically aligned liquid crystal molecules, and the alignment layer and the vertically aligned liquid crystal layer should maintain integrity with the horizontally aligned layer after stripping. The alignment layer contains vertically aligned liquid crystal components, so in addition to drying and UV exposure, UV curing should be carried out to provide conditions for liquid crystal molecule film formation.

The temperature of the drying process can be 50° C. to 150° C., preferably 60° C. to 130° C.; drying time is 10 s to 600s, preferably 30 s to 300s; UV exposure amount is 1 mJ to 50 mJ, preferably 5 mJ to 40 mJ; UV curing amount is 100 mJ to 20000 mJ, preferably 300 mJ to 15000 mJ; during UV curing, inert gas can be added to the atmosphere, preferably nitrogen, and the concentration of nitrogen can be greater than 95%.

5) After the preparation of the liquid crystal layer single film is completed, preparing a laminated structure according to the structures of “the horizontally aligned layer+the alignment layer and the vertically aligned liquid crystal layer+an adhesive layer+the horizontally aligned liquid crystal layer”, or a layer of TAC substrate 400 with phase retardation may be laminated.

In the example of the present application, the substrate 400 may be one of a glass substrate, a metal substrate, a ceramic substrate, and a plastic substrate. In addition, other organic materials may also be used, which is not specifically limited here.

In the case where the substrate 400 is an organic material, the material of the substrate 400 may comprise a cellulose derivative, polyolefin, polyester, polycarbonate, polyacrylate (acrylic resin), polyarylate, polyethersulfone, polyimide, polyphenylene sulfide, polyphenyl ether, nylon, polystyrene, or the like.

Wherein, a plastic base material such as polyester, polystyrene, polyacrylate, polyolefin, cellulose derivative, polyarylate, and polycarbonate is preferable.

And the substrate 400 may be a metal material, a polyethylene terephthalate (PET), a cellulose derivative (PVA), a polynorbornene (COP), a cellulose triacetate film (TAC), or the like.

As the shape of the substrate 400, the substrate 400 may be a flat plate or a curved plate. Of course, other shapes are also possible, and the substrate 400 may have an electrode layer, an anti-reflection function, a reflection function, or the like, as necessary.

The polymerizable composition solution may be applied to the surface of the substrate 400 by a coater method, a rod coating method, a spin coating method, a roll coating method, a direct gravure coating method, a reverse gravure coating method, a flexo coating method, an ink-jet method, a die coating method, a cap coating method, a dip coating method, and a slit coating method.

The examples of the present application are described above with reference to the drawings, but the present application is not limited to the above specific examples, which are only illustrative and not restrictive, and those skilled in the art can make various forms without departing from the spirit of the present application and the protection scope of the claims under the enlightenment of the present application, all of which will fall within the protection scope of this application.

What is claimed is:

1. A phase difference film comprising a first film layer, a second film layer, and a third film layer which are sequentially stacked;
the first film layer is a spiral A film formed by adding a chiral agent into a positive dispersion type rod-shaped liquid crystal;
the second film layer is a C film formed by a positive dispersion type rod-shaped liquid crystal;
the third film layer is a spiral A film formed by adding a chiral agent to a positive dispersion type rod-shaped liquid crystal.

2. The phase difference film according to claim 1, wherein the orientation angle of a liquid crystal molecule on the side of the first film layer away from the second film layer is in a range of −30° to 30°.

3. The phase difference film according to claim 1, wherein the orientation angle of a liquid crystal molecule on the side of the first film layer away from the second film layer is in a range of −20° to 20°.

4. The phase difference film according to claim 1, wherein the total twist angle of a liquid crystal molecule of the first film layer is in a range of −60° to 60°.

5. The phase difference film according to claim 1, wherein the total twist angle of a liquid crystal molecule of the first film layer is in a range of 10° to 30°, or ±40° to 60°.

6. The phase difference film according to claim 1, wherein a value of (ne-no) at a wavelength of 550 nm multiplied by a film thickness of the first layer is in a range of 150 nm to 450 nm.

7. The phase difference film according to claim 1, wherein a value of (ne-no) at a wavelength of 550 nm multiplied by a film thickness of the first layer is in a range of 200 nm to 400 nm.

8. The phase difference film according to claim 1, wherein a value of (ne-no) at a wavelength of 550 nm multiplied by a film thickness of the second film layer is in a range of 40 nm to 250 nm.

9. The phase difference film according to claim 1, wherein a value of (ne-no) at a wavelength of 550 nm multiplied by a film thickness of the second film layer is in a range of 50 nm to 140 nm, or 160 nm to 240 nm.

10. The phase difference film according to claim 1, wherein the orientation angle of a liquid crystal molecule on the side of the third film layer away from the second film layer is in a range of ±0° to 20°, or 65° to 90°.

11. The phase difference film according to claim 1, wherein the orientation angle of a liquid crystal molecule on the side of the third film layer away from the second film layer is in a range of 70° to 90°.

12. The phase difference film according to claim 1, wherein the total twist angle of a liquid crystal molecule of the third film layer is in a range of ±70° to 200°.

13. The phase difference film according to claim 1, wherein the total twist angle of a liquid crystal molecule of the third film layer is in a range of ±75° to 95°, or ±170° to 200°.

14. The phase difference film according to claim 1, wherein the value of (ne-no) at a wavelength of 550 nm multiplied by a film thickness of the third layer is in a range of 100 nm to 370 nm.

15. A polymerizable composition contained in a spiral A film formed by adding a chiral agent into a positive dispersion rod-shaped liquid crystal, the spiral A film is the spiral A film according to claim 1;
the polymerizable composition comprises: an acrylic resin, a first material comprising a compound with formula I, and a second material comprising a compound with formula II;
the formula I is as follows: 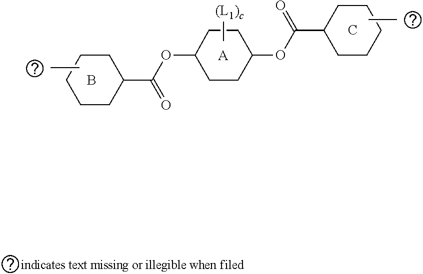
wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
in the formula I, 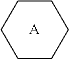
comprises any one of 1,4-cyclohexylene, 1,4-phenylene, 2,6-naphthylene, 1,5-naphthylene and 1,4-naphthylene;
in the formula I, 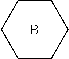
comprises any one of 1,4-cyclohexylene, 1,4-phenylene, 2,6-naphthylene, 1,5-naphthylene, and 1,4-naphthylene;
in the formula I, 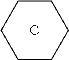
comprises any one of 1,4-cyclohexylene, 1,4-phenylene, 2,6-naphthylene, 1,5-naphthylene, and 1,4-naphthylene;
Sp₁ is a spacer, Sp₂ is a spacer;
P₁ comprises a polymerizable group or H, P₂ comprises a polymerizable group or H, and at least one of P₁ and P₂ is a polymerizable group;
a is 1, 2 or 3; b is 1, 2 or 3; c is 1, 2 or 3;
the formula II is as follows: 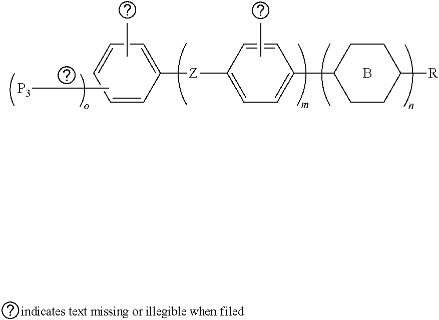
in the formula II, R comprises any one of H, a linear chain alkyl group having 1 to 25 carbon atoms, a branched chain alkyl group having 3 to 25 carbon atoms, and a cyclic alkyl group having 3 to 25 carbon atoms;
Z comprises any one of a single bond, an alkyl group having 1 to 10 carbon atoms, and an alkenyl group having 2 to 10 carbon atoms;
L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
L₃ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
in the formula II, 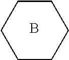
comprises any one of an aryl group, a heteroaryl group, an alicyclic group, a heterocyclic group and a fused ring;
Sp₃ is a spacer;
P₃ comprises a polymerizable group or H;
d is 0, 1, 2, 3 or 4;
e is 0, 1, 2, 3 or 4;
mis 0, 1 or 2, n is 0, 1 or 2, and m+n≥1;
o is 1, 2, or 3.

16. A polymerizable composition contained in a C film formed of a positive dispersion type rod-shaped liquid crystal, the C film is the C film according to claim 1;
the polymer composition comprises: acrylic resin, a first material and a second material, wherein the first material comprises a compound with a formula I, and the second material comprises a compound with a formula IV and/or a compound with a formula III;
the formula I is as follows: 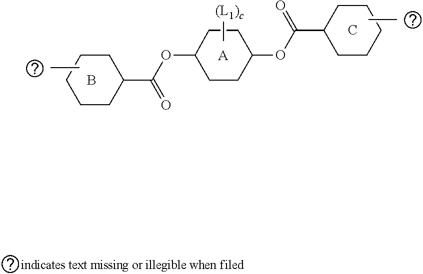
wherein L₁ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
in the formula I, 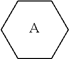
comprises any one of 1,4-cyclohexylene, 1,4-phenylene, 2,6-naphthylene, 1,5-naphthylene, and 1,4-naphthylene;
in the formula I, 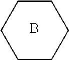
comprises any one of 1,4-cyclohexylene, 1,4-phenylene, 2,6-naphthylene, 1,5-naphthylene, and 1,4-naphthylene;
in the formula I, 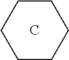
comprises any one of 1,4-cyclohexylene, 1,4-phenylene, 2,6-naphthylene, 1,5-naphthylene, and 1,4-naphthylene;
Sp₁ is a spacer, Sp₂ is a spacer;
P₁ comprises a polymerizable group or H, P₂ comprises a polymerizable group or H, and at least one of P₁ and P₂ is a polymerizable group;
a is 1, 2 or 3; b is 1, 2 or 3; c is 1, 2 or 3;
the formula IV is as follows: 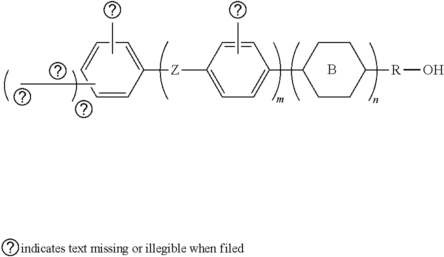
the formula III is as follow: 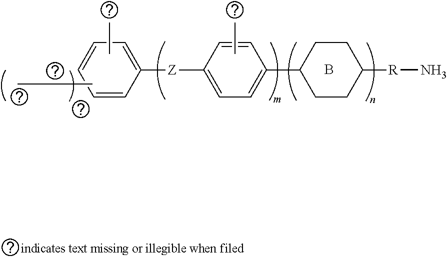
in the formula IV and the formula III, R comprises any one of H, a linear chain alkyl group having 1 to 25 carbon atoms, a branched chain alkyl group having 3 to 25 carbon atoms, and a cyclic alkyl group having 3 to 25 carbon atoms;
Z comprises any one of a single bond, an alkyl group having 1 to 10 carbon atoms, and an alkenyl group having 2 to 10 carbon atoms;
L₂ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
L₃ comprises any one of H, F, Cl, CN, a linear chain alkyl group having 1 to 25 carbon atoms, a branched chain alkyl group having 3 to 25 carbon atoms, a cyclic alkyl group having 3 to 25 carbon atoms, an alkenyl group having 2 to 25 carbon atoms, and an alkynyl group having 2 to 25 carbon atoms;
in the formula IV and formula III, 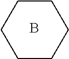
comprises any one of an aryl group, a heteroaryl group, an alicyclic group, a heterocyclic group and a fused ring;
Sp₃ is a spacer;
P₃ comprises a polymerizable group or H;
d is 0, 1, 2, 3 or 4;
e is 0, 1, 2, 3 or 4;
f is 0, 1, 2, 3 or 4;
g is 0, 1, 2, 3 or 4;
mis 0, 1 or 2, n is 0, 1 or 2, and m+n≥1;
o is 1, 2 or 3 and h is 1, 2 or 3.

17. A method for preparing a phase difference film, to produce the phase difference film according to claim 1, the method comprises:
treating a substrate;
coating an alignment layer on the substrate;
coating a horizontally aligned liquid crystal layer on the alignment layer;
coating a vertically aligned liquid crystal layer on the substrate;
preparing a laminated structure according to the horizontally aligned liquid crystal layer, the vertically aligned liquid crystal layer, the horizontally aligned liquid crystal layer to form a phase difference film.

18. A method for preparing a phase difference film, to produce the phase difference film according to claim 1, the method comprises:
treating a substrate;
coating an alignment layer on the substrate;
coating a horizontally aligned liquid crystal layer on the alignment layer;
coating an alignment layer and a horizontally aligned liquid crystal layer on the substrate;
preparing a laminated structure according to the horizontally aligned liquid crystal layer and the alignment layer, the vertically aligned liquid crystal layer, the horizontally aligned liquid crystal layer to form a phase difference film.

19. The method for preparing a phase difference film according to claim 18,
wherein after coating the alignment layer and the horizontally aligned liquid crystal layer on the substrate, drying and UV exposure are performed to the alignment layer; drying, UV exposure and UV curing are performed to the vertically aligned liquid crystal layer; wherein the drying temperature is in a range of 50° C. to 150° C., the drying time is in a range of 10 s to 600 s, the UV exposure amount is in a range of 1 mJ to 50 mJ, the UV curing amount is in a range of 100 mJ to 20000 mJ, inert gas is added in the UV curing process, and the concentration of the inert gas is more than 95%.

20. The method for preparing a phase difference film according to claim 18, wherein the substrate is a flat plate or a curved plate.
